(19) United States
(12) Patent Application Publication
(10) Pub. No.: US 2019/0233662 A1
(43) Pub. Date: Aug. 1, 2019

(54) ELECTROPHORETIC INK PROVIDING COLOURED AND TRANSPARENT STATES

(71) Applicant: BASF SE, Ludwigshafen am Rhein (DE)

(72) Inventors: Ying GUO, Riehen (DE); Charles FREUDENREICH, Riedisheim (FR); Gerardus DE KEYZER, Basel (CH); Milijana JOVIC, Uzwil (CH)

(73) Assignee: BASF SE, Ludwigshafen am Rhein (DE)

(21) Appl. No.: 16/312,136

(22) PCT Filed: Jul. 10, 2017
(86) PCT No.: PCT/EP2017/067278

§ 371 Date: Dec. 20, 2018

(30) Foreign Application Priority Data
Jul. 12, 2016 (EP) 16179079.5

(51) Int. Cl. C09D 5/44; C09D 11/102; C09D 11/033; C09D 11/037; G02F 1/167; G02F 1/1681

(52) U.S. Cl. CPC C09D 5/448; C09D 11/102; C09D 11/033; C09D 11/037; G02F 2001/1678; C09D 5/4419; G02F 1/167; G02F 1/1681; C09D 5/4473

(57) ABSTRACT

The present invention refers to an electrophoretic ink, a method for preparing an electrophoretic ink, an electrophoretic display comprising the electrophoretic ink, a smart window comprising the electrophoretic ink as well as the use of the electrophoretic ink in electrophoretic displays or smart windows and the use of a mixture of charge control agents for the preparation of an electrophoretic ink.

### FIELD OF THE INVENTION

The present invention refers to an electrophoretic ink, a method for preparing an electrophoretic ink, an electrophoretic display comprising the electrophoretic ink, a smart window comprising the electrophoretic ink as well as the use of the electrophoretic ink in electrophoretic displays or smart windows and the use of a mixture of charge control agents for the preparation of an electrophoretic ink.

### BACKGROUND OF THE INVENTION

Reflective and bright displays featured as low-cost and outdoor readable as well as smart windows have great market potential. The current reflective displays are usually based on electrophoretic phenomenon and thus are referred to as electrophoretic displays (e-displays).

Such e-displays and smart windows are well known in the art. For example, U.S. Pat. No. 7,110,162 B2 refers to an electrophoretic ink comprising a fluorinated solvent as a continuous phase, charged pigment particles or pigment containing microcapsules as a dispersed phase and a charge controlling agent which comprises: (i) a soluble fluorinated electron accepting or proton donating compound or polymer in the continuous phase and an electron donating or proton accepting compound or polymer in the dispersed phase; or (ii) a soluble fluorinated electron donating or proton accepting compound or polymer in the continuous phase and an electron accepting or proton donating compound or polymer in the dispersed phase. EP 1 231 500 A2 refers to electrically addressable ink comprising a microcapsule, said microcapsule comprising: a first particle having a first charge; and a second particle having a second charge; wherein applying an electric field having a first polarity to said microcapsule effects a perceived color change by causing one of said first and second particles to migrate in a direction responsive to said field. WO 2011/046564 A1 dual color electronically addressable ink includes a non-polar carrier fluid, a first colorant of a first color, and a second colorant of a second color that is different than the first color. The first colorant includes a particle core (C1), and a basic functional group (BFG) attached to a surface of the particle core (C1). The second colorant includes a particle core (C2), and an acidic functional group (AFG) attached to a surface of the particle core (C2). The acidic functional group (AFG) and the basic functional group (BFG) are configured to interact within the non-polar carrier fluid to generate a charge on the first colorant and an opposite charge on the second colorant.

However, commercially available electrophoretic ink (e-ink) materials are typically only able to switch between a white, grey or a black reflective state. That is to say, they cannot provide a transparent state and therefore cannot be used in smart windows. Furthermore, the commercially available e-displays filled with e-ink have the drawback that they typically do not provide the desired brightness. In addition thereto, the commercially available e-displays typically provide a decreased amount of pixels, i.e. one third in red, one third in blue and one third in green, such that the colour spectrum of the displays is restricted. The application of the currently available e-inks is hence limited to e-displays and completely impossible in smart windows. Moreover, the commercially available e-inks require encapsulation and/or surface-grafting of pigments which increase the complexity of the process and the cost.

Therefore, there is a need in the art for providing an electrophoretic ink which avoids the foregoing disadvantages and especially allows for the switching between transparent and multi-coloured or translucent states when used in electrophoretic displays or smart windows. Furthermore, it is desirable to provide an electrophoretic ink having a high brightness as well as covering a large colour spectrum, i.e. all pixels in red, green and blue, when used in electrophoretic displays. In particular, to decrease the complexity of the process and the cost, it is desirable to provide an electrophoretic ink which avoids the use of pigments having surface functionalization.

Accordingly, it is an object of the present invention to provide an electrophoretic ink, especially an electrophoretic ink that can be used in electrophoretic displays or smart windows. Furthermore, it is an object of the present invention to provide an electrophoretic ink that allows for the switching between transparent and translucent and non-transparent states in smart window applications. Furthermore, it is an object of the present invention to provide an electrophoretic ink that allows for the switching between white and black and multi-coloured states in e-display applications. It is another object of the present invention to provide an electrophoretic ink that provides a high brightness in an e-display. It is a further object of the present invention to provide an electrophoretic ink that covers a large colour spectrum. It is an even further object of the present invention to provide an electrophoretic ink that is free of pigments having surface functionalization.

### SUMMARY OF THE INVENTION

The foregoing and other objects are solved by the subject-matter of the present invention. According to a first aspect of the present invention, an electrophoretic ink is provided. The electrophoretic ink comprises
a) at least one carrier fluid,
b) pigment particles dispersed in the at least one carrier fluid, and
c) a mixture of charge control agents, the mixture of charge control agents comprises
   i) at least one polydimethylsiloxane substituted primary amine and/or polydimethylsiloxane substituted secondary amine and/or polydimethylsiloxane substituted tertiary amine, and
   ii) at least one polydimethylsiloxane substituted quaternary ammonium with counterion.

The inventors surprisingly found out that an electrophoretic ink as defined herein, namely an electrophoretic ink comprising at least one carrier fluid, pigment particles dispersed in the carrier fluid and a defined mixture of charge control agents, can be used as electrophoretic ink in electrophoretic displays or smart windows and allows for the switching between transparent and multi-coloured or translucent states. Furthermore, the electrophoretic ink has a high brightness and covers a large colour spectrum. Furthermore, the electrophoretic ink as defined herein is free of pigments having surface functionalization.

According to another aspect of the present invention, a method for preparing an electrophoretic ink is provided. The method comprising the steps of
a) providing at least one carrier fluid as defined herein,
b) providing pigment particles as defined herein,
c) optionally providing at least one dispersing agent as defined herein,
d) providing a mixture of charge control agents as defined herein, and
e) combining the at least one carrier fluid of step a), the pigment particles of step b), the optional dispersing agent of step c) and the mixture of charge control agents of step d).

According to a further aspect of the present invention, an electrophoretic display comprising a) a top layer and a bottom layer, wherein at least one is transparent, and b) an array of cells sandwiched between the top layer and the bottom layer and the cells are at least partially filled with the electrophoretic ink, as defined herein, is provided.

According to still another aspect of the present invention, a smart window comprising a) a top layer and a bottom layer, wherein at least one is transparent, preferably the top layer and the bottom layer are transparent, and b) an array of cells sandwiched between the top layer and the bottom layer and the cells are at least partially filled with the electrophoretic ink, as defined herein, is provided.

According to an even further aspect of the present invention, the use of the electrophoretic ink as defined herein in electrophoretic displays or smart windows is provided.

According to a still further aspect of the present invention, the use of a mixture of charge control agents as defined herein for the preparation of an electrophoretic ink is provided.

Advantageous embodiments of the inventive electrophoretic ink are defined in the corresponding sub-claims.

According to one embodiment, the at least one carrier fluid is selected from the group comprising aliphatic hydrocarbons, halogenated alkanes, silicon oils and mixtures thereof.

According to another embodiment, the pigment particles are selected from the group consisting of color pigments, effect pigments, electrically conductive pigments, magnetically shielding pigments, fluorescent pigments, extender pigments, anticorrosion pigments, organic pigments, inorganic pigments and mixtures thereof.

According to yet another embodiment, the electrophoretic ink comprises at least one dispersing agent, preferably the at least one dispersing agent is of the following Formula (I)

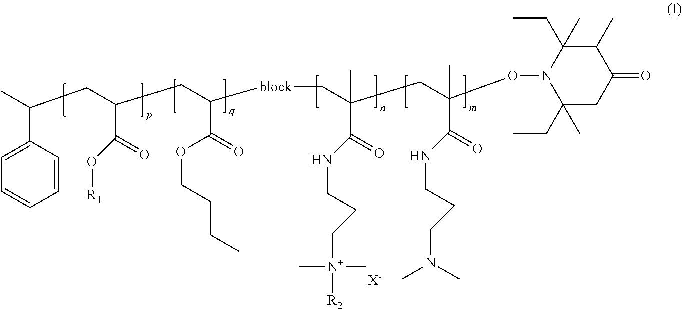

wherein p+q is an integer in the range from 30 to 200, n+m is an integer in the range from 5 to 50, X⁻ is an anion of a monovalent organic or inorganic acid, R₁ is a C₄-C₂₂-linear or branched alkyl group and R₂ is a C₁-C₁₂-comprising group.

According to one embodiment, the mixture of charge control agents comprises the at least one polydimethylsiloxane substituted primary amine and/or polydimethylsiloxane substituted secondary amine and/or polydimethylsiloxane substituted tertiary amine of i) and the at least one polydimethylsiloxane substituted quaternary ammonium with counterion of ii) in a weight ratio [i)/ii)] ranging from 1:10 to 1:1.5, preferably from 1:8 to 1:1.8 and most preferably from 1:5 to 1:2.

According to another embodiment, the at least one polydimethylsiloxane substituted primary amine and/or polydimethylsiloxane substituted secondary amine and/or polydimethylsiloxane substituted tertiary amine of i) is a polydimethylsiloxane substituted tertiary amine.

According to yet another embodiment, the at least one polydimethylsiloxane substituted primary amine and/or polydimethylsiloxane substituted secondary amine and/or polydimethylsiloxane substituted tertiary amine of i) is a compound of the following Formula (IIa)

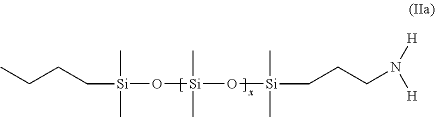

wherein x is an integer in the range from 5 to 20, and/or a compound of the following Formula (IIb)

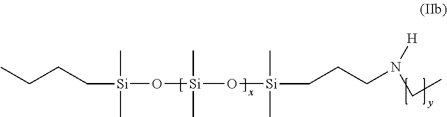

wherein x is an integer in the range from 5 to 20 and y is an integer in the range from 0 to 12, and/or a compound of the following Formula (IIc)

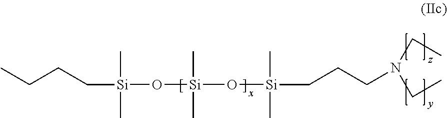

According to one embodiment, the at least one polydimethylsiloxane substituted quaternary ammonium with counterion of ii) is a compound of the following Formula (III)

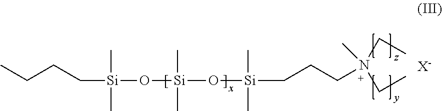

wherein x is an integer in the range from 5 to 20; y and z are independently from each other and are an integer in the range from 0 to 12 and X⁻ is selected from the group consisting of iodide, bromide, chloride, methylsulfate anion and ethylsulfate anion.

According to another embodiment, the at least one polydimethylsiloxane substituted quaternary ammonium with counterion of ii) is a compound of the following Formula (IV)

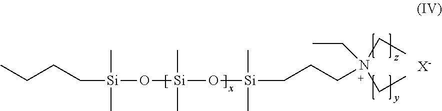

wherein x is an integer in the range from 5 to 20; y and z are independently from each other and are an integer in the range from 0 to 12 and X⁻ is selected from the group consisting of iodide, bromide, chloride, methylsulfate anion and ethylsulfate anion.

According to yet another embodiment, x in Formula (II) and Formula (III) or Formula (IV) is the same and/or y in Formula (II) and Formula (III) or Formula (IV) is the same and/or z in Formula (II) and Formula (III) or Formula (IV) is the same.

According to one embodiment, the electrophoretic ink comprises the mixture of charge control agents in an amount of 5 to 40 wt.-%, preferably in an amount of 10 to 30 wt.-%, based on the total weight of the electrophoretic ink.

In the following, the details and preferred embodiments of the inventive process will be described in more detail. It is to be understood that these technical details and embodiments also apply to the inventive products and use.

### DETAILED DESCRIPTION OF THE INVENTION

The electrophoretic ink comprises
a) at least one carrier fluid,
b) pigment particles dispersed in the at least one carrier fluid, and
c) a mixture of charge control agents, the mixture of charge control agents comprises
   i) at least one polydimethylsiloxane substituted primary amine and/or polydimethylsiloxane substituted secondary amine and/or polydimethylsiloxane substituted tertiary amine, and
   ii) at least one polydimethylsiloxane substituted quaternary ammonium with counterion.

Accordingly, one essential component of the electrophoretic ink is the at least one carrier fluid.

The term “at least one” means that the carrier fluid comprises, preferably consists of, one or more carrier fluid(s).

In one embodiment, the at least one carrier fluid comprises, preferably consists of, one carrier fluid. Alternatively, the at least one carrier fluid comprises, preferably consists of, two or more carrier fluids. For example, the at least one carrier fluid comprises, preferably consists of, two or three carrier fluids. In other words, if the at least one carrier fluid comprises, preferably consists of, two or more carrier fluids, the at least one carrier fluid comprises, preferably consists of, a mixture of different carrier fluids.

If the at least one carrier fluid is a mixture of different carrier fluids, the mixture comprises, preferably consists of, two to five carrier fluids. For example, the mixture of carrier fluids comprises, preferably consists of, two or three carrier fluids.

Preferably, the at least one carrier fluid comprises, more preferably consists of, one carrier fluid.

For example, the at least one carrier fluid has a low dielectric constant, for example, about 4 or less, such as in the range from 0.5 to 2.

In one embodiment, the at least one carrier fluid is substantially free of ions.

Suitable carrier fluids are selected from the group comprising aliphatic hydrocarbons, halogenated alkanes, silicon oils and mixtures thereof.

Examples of aliphatic hydrocarbons include heptane, octane, nonane, decane, dodecane, tetradecane, hexane, cyclohexane, paraffinic solvents such as ISOPAR™ (Exxon), NORPAR™ (Exxon), SHELL-SOL™ (Shell), and SOL-TROL™ (Shell) series. The use of aliphatic hydrocarbons as the at least one carrier fluid is advantageous due to their good dielectric strength and nonreactivity.

The aliphatic hydrocarbon preferably has a dielectric constant of about 4 or less, such as in the range from 0.5 to 2. Additionally or alternatively, the aliphatic hydrocarbon has a refractive index in the range from 1.4 to 1.5, such as in the range from 1.4 to 1.45.

In one embodiment, the aliphatic hydrocarbon preferably has a density in the range from 0.6 to 0.8 gcm⁻³, such as in the range from 0.7 to 0.8 gcm⁻³.

Halogenated alkanes may include partially or completely halogenated alkanes. For example, the halogenated alkane is selected from the group comprising, preferably consisting of, tetrafluorodibromoethylene, tetrachloroethylene, trifluorochloroethylene, carbon tetrachloride and mixtures thereof.

The halogenated alkane preferably has a dielectric constant of about 4 or less, such as in the range from 1.5 to 2. Additionally or alternatively, the halogenated alkane has a refractive index of about 1.4 or less, such as in the range from 1.3 to 1.4.

In one embodiment, the halogenated alkane preferably has a density in the range from 1.0 to 1.9 gcm⁻³, such as in the range from 1.3 to 1.8 gcm⁻³.

Examples of silicone oils include octamethyl cyclosiloxane, poly(methyl phenyl siloxane), hexamethyldisiloxane, polydimethylsiloxane and mixtures thereof.

The silicone oil preferably has a dielectric constant of about 3 or less, such as in the range from 2 to 2.8. Additionally or alternatively, the silicone oil has a refractive index of 1.45 or less, such as in the range from 1.4 to 1.45.

In one embodiment, the silicone oil preferably has a density in the range from 0.8 to 1.0 gcm⁻³, such as in the range from 0.9 to 1.0 gcm⁻³.

The electrophoretic ink preferably comprises the at least one carrier fluid in an amount ranging from 30 to 95 wt.-%, more preferably from 40 to 94.5 wt.-% and most preferably from 50 to 94 wt.-%, based on the total weight of the electrophoretic ink.

It is a further requirement of the present invention that the electrophoretic ink comprises pigment particles dispersed in the at least one carrier fluid.

It is appreciated that the electrophoretic ink is preferably free of pigments having surface functionalization such as encapsulated pigments and/or surface-grafted pigments.

In one embodiment, the pigment particles comprise, preferably consist of, one kind of pigment particles. Alternatively, the pigment particles comprise, preferably consist of, two or more kinds of pigment particles. For example, the pigment particles comprise, preferably consist of, two or three kinds of pigment particles.

Preferably, the pigment particles comprise, preferably consist of, one kind of pigment particles.

In one embodiment, the pigment particles are selected from the group consisting of color pigments, effect pigments, electrically conductive pigments, magnetically shielding pigments, fluorescent pigments, extender pigments, anticorrosion pigments, organic pigments, inorganic pigments and mixtures thereof. Preferably, the pigment particles are color pigments.

If the pigment particles are color pigments, the pigment particles are preferably selected from black pigment particles, cyan pigment particles, magenta pigment particles, yellow pigment particles and mixtures thereof.

Black pigment particles are preferably selected from pigment particles of the following Formula (a) and/or Formula (b)

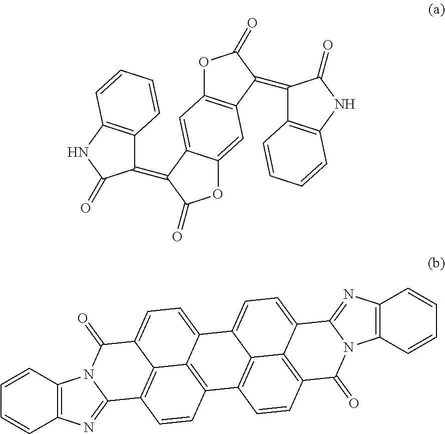 [SMILES: O=C1Nc2ccccc2/C1=C1/C(=O)Oc2cc3c(cc21)OC(=O)/C3=C1\C(=O)Nc2ccccc21 ; O=c1c2ccc3c4ccc5c6c(ccc(c7ccc(c2c37)c2nc3ccccc3n12)c46)c(=O)n1c2ccccc2nc51]

More preferably, black pigment particles are selected from pigment particles of Formula (a) or Formula (b).

Cyan pigment particles are preferably selected from pigment particles of the following Formula (c) and/or Formula (d)

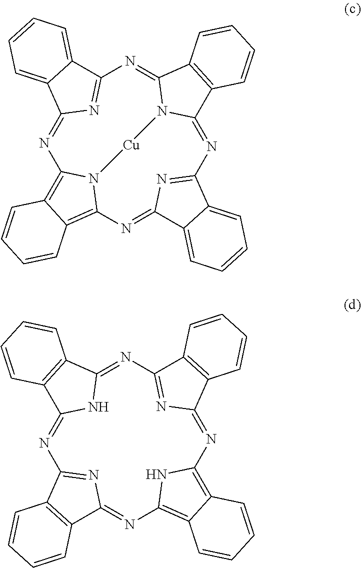

More preferably, cyan pigment particles are selected from pigment particles of Formula (c) or Formula (d).

Magenta pigment particles are preferably selected from pigment particles of the following Formula (e) and/or Formula (f) and/or Formula (g)

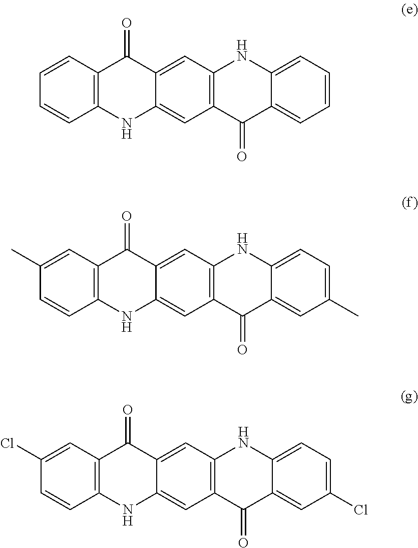

More preferably, magenta pigment particles are selected from pigment particles of Formula (e) or Formula (f) or Formula (g).

Yellow pigment particles are preferably selected from pigment particles of the following Formula (h) and/or Formula (i) and/or Formula (j) and/or Formula (k)

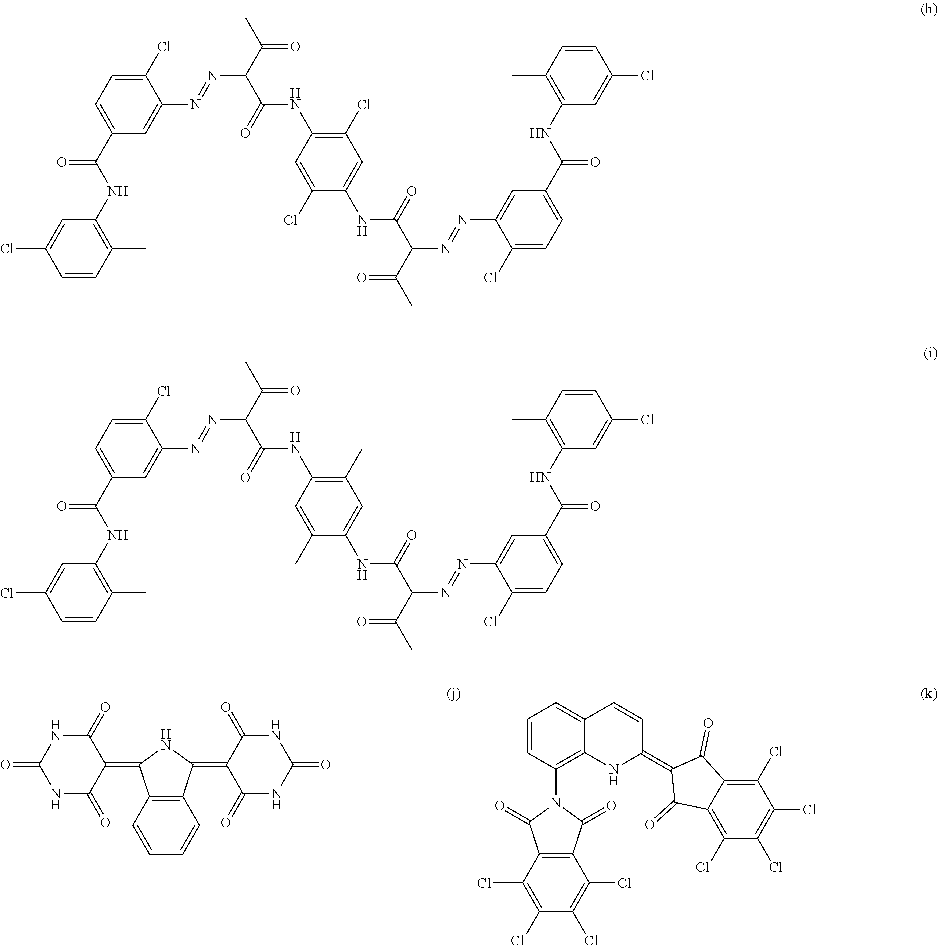 [SMILES: CC(=O)C(/N=N/c1cc(C(=O)Nc2cc(Cl)ccc2C)ccc1Cl)C(=O)Nc1cc(Cl)c(NC(=O)C(/N=N/c2cc(C(=O)Nc3cc(Cl)ccc3C)ccc2Cl)C(C)=O)cc1Cl ; CC(=O)C(/N=N/c1cc(C(=O)Nc2cc(Cl)ccc2C)ccc1Cl)C(=O)Nc1cc(C)c(NC(=O)C(/N=N/c2cc(C(=O)Nc3cc(Cl)ccc3C)ccc2Cl)C(C)=O)cc1C ; O=C1NC(=O)C(=c2[nH]c(=C3C(=O)NC(=O)NC3=O)c3ccccc23)C(=O)N1 ; O=C1C(=C2C=Cc3cccc(N4C(=O)c5c(Cl)c(Cl)c(Cl)c(Cl)c5C4=O)c3N2)C(=O)c2c(Cl)c(Cl)c(Cl)c(Cl)c21]

More preferably, yellow pigment particles are selected from pigment particles of Formula (h) or Formula (i) or Formula (j) or Formula (k).

The pigment particles preferably have a particle size d₅₀ of ≤100 nm, preferably of ≤75 nm and most preferably of ≤50 nm. The value d₅₀ refers to the weight median particle size, i.e. 50 wt.-% of all particles are bigger or smaller than this particle size. The particle size can be measured by using dynamic light scattering or TEM. For example, the particle size can be determined by using a Zetasizer Nano of Malvern Instruments Ltd.

The electrophoretic ink comprises the pigment particles preferably in an amount ranging from 1 to 15 wt.-%, more preferably from 1.5 to 13 wt.-% and most preferably from 2 to 10 wt.-%, based on the total weight of the electrophoretic ink.

In one embodiment, the pigment particles are dispersed in the at least one carrier fluid by using at least one dispersing agent in order to avoid sedimentation.

Thus, the electrophoretic ink preferably comprises at least one dispersing agent.

The at least one dispersing agent can be any dispersing agent known in the art for electrophoretic inks which are used in electrophoretic displays.

The at least one dispersing agent comprises, preferably consists of, one dispersing agent. Alternatively, the at least one dispersing agent comprises, preferably consists of, two or more dispersing agent. For example, the at least one dispersing agent comprises, preferably consists of, two or three dispersing agents.

Preferably, the at least one dispersing agent comprises, more preferably consists of, one dispersing agent.

For example, the at least one dispersing agent is a compound of the following Formula (I)

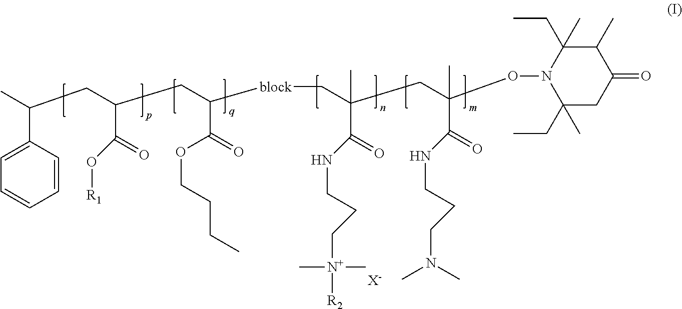

wherein p+q is an integer in the range from 30 to 200, n+m is an integer in the range from 5 to 50, X⁻ is an anion of a monovalent organic or inorganic acid, R₁ is a C₄-C₂₂-linear or branched alkyl group and R₂ is a C₁-C₁₂-comprising group.

The term “block” in Formula (I) in the meaning of the present application indicates the spatial separation of the monomers on each side of said term. That is to say, the monomers of the p and q elements form a block copolymer and the monomers of the n and m elements form another block copolymer, wherein the term “block” represents the separation of the said blocks.

It is appreciated that R₁ is a C₄-C₂₂-linear or branched alkyl group.

As used herein, the term “alkyl” is a radical of a saturated aliphatic group, including linear chain alkyl groups and branched chain alkyl groups, wherein such linear and branched chain alkyl groups may each be optionally substituted, e.g. with a hydroxyl group.

Thus, R₁ can be C₄-C₂₂ linear or branched alkyl such as substituted or unsubstituted C₄-C₂₂ linear or branched alkyl, preferably R₁ is C₆-C₂₀ linear or branched alkyl such as substituted or unsubstituted C₆-C₂₀ linear or branched alkyl, even more preferably R₁ is C₈-C₁₈ linear or branched alkyl such as substituted or unsubstituted C₈-C₁₈ linear or branched alkyl and most preferably R₁ is C₁₀-C₁₆ linear or branched alkyl such as substituted or unsubstituted C₁₀-C₁₆ linear or branched alkyl.

In one embodiment, R₁ is unsubstituted C₄-C₂₂ linear alkyl, preferably unsubstituted C₆-020 linear alkyl, even more preferably unsubstituted C₈-C₁₈ linear alkyl and most preferably unsubstituted C₁₀-C₁₆ linear alkyl.

As used herein, the term “C₁-C₁₂-comprising group” is a radical of an unsubstituted or substituted saturated aliphatic or aromatic group, including unsubstituted or substituted linear chain alkyl groups and unsubstituted or substituted branched chain alkyl groups and unsubstituted or substituted aromatic groups, preferably substituted aromatic groups.

Thus, R₂ can be C₁-C₁₂-alkyl such as unsubstituted, linear or branched C₁-C₁₂-alkyl, preferably R₂ is C₂-C₁₀-alkyl such as unsubstituted, linear or branched C₂-C₁₀-alkyl, more preferably R₂ is C₂-C₉-alkyl such as unsubstituted, linear or branched C₂-C₉-alkyl, even more preferably R₂ is C₂-C₈-alkyl such as unsubstituted, linear or branched C₂-C₈-alkyl. Alternatively, R₂ can be C₁-C₁₂-alkyl such as substituted, linear or branched C₁-C₁₂-alkyl, preferably R₂ is C₂-C₁₀-alkyl such as substituted, linear or branched C₂-C₁₀-alkyl, more preferably R₂ is C₂-C₉-alkyl such as substituted, linear or branched C₂-C₉-alkyl, even more preferably R₂ is C₂-C₈-alkyl such as substituted, linear or branched C₂-C₈-alkyl, for example partially or completely halogenated, such as chlorinated, linear or branched C₂-C₈-alkyl.

For example, R₂ is unsubstituted, linear C₁-C₁₂-alkyl, preferably unsubstituted, linear C₂-C₁₀-alkyl, more preferably unsubstituted, linear C₂-C₉-alkyl, and even more preferably unsubstituted, linear C₂-C₈-alkyl.

In one embodiment, R₂ is an unsubstituted aromatic C₆-C₁₂-group, preferably R₂ is an unsubstituted aromatic C₆-C₁₀-group, more preferably R₂ is an unsubstituted aromatic C₆- or C₇-group, for example a phenyl or benzyl group. Alternatively, R₂ is a substituted aromatic C₆-C₁₂-group, preferably R₂ is a substituted aromatic C₆-C₁₀-group, more preferably R₂ is a substituted aromatic C₆- or C₇-group, for example a halogenated, such as chlorinated, phenyl, methylphenyl or benzyl group, e.g. a 3-chloro-4-methylphenyl group or a 3-chloro-5-methylphenyl group.

In order to increase the affinity of the dispersing agent to the pigment particles, it is advantageous that R₂ is a substituted aromatic C₆-C₁₂-group.

It is appreciated that X⁻ is an anion of a monovalent organic or inorganic acid. For example, X⁻ is an anion of a monovalent inorganic acid such as chloride, bromide or iodide. In one embodiment, X⁻ is bromide or iodide

A specific ratio of the blocks is advantageous in order to obtain a good balance between affinity of the dispersing agent to the pigment particles and affinity of the dispersing agent to the carrier fluid. It is thus one requirement of the present invention that the sum of p+q is an integer in the range from 30 to 200 and that the sum of n+m is an integer in the range from 5 to 50.

In one embodiment, the sum of p+q is an integer in the range from 50 to 150, preferably an integer in the range from 50 to 125 and most preferably an integer in the range from 50 to 100.

It is appreciated that p is preferably an integer in the range from 45 to 60. Additionally, q is preferably an integer in the range from 15 to 30.

In one embodiment, the sum of n+m is an integer in the range from 5 to 40, preferably an integer in the range from 5 to 30 and most preferably an integer in the range from 5 to 20.

In one embodiment, n is preferably an integer in the range from 0 to 5. Additionally, m is an integer in the range from 6 to 11. For example, n is 0 and m is 11.

If present, the electrophoretic ink comprises the at least one dispersing agent preferably in an amount ranging from 0.1 to 1.5 wt.-%, more preferably from 0.15 to 1.3 wt.-% and most preferably from 0.2 to 1.0 wt.-%, based on the total weight of the electrophoretic ink.

In order to achieve the switching between the multi-coloured and the transparent state it is essential that the electrophoretic ink comprises a specific mixture of charge control agents.

It is thus one requirement of the present invention that the mixture of charge control agents comprises
i) at least one polydimethylsiloxane substituted primary amine and/or polydimethylsiloxane substituted secondary amine and/or polydimethylsiloxane substituted tertiary amine, and
ii) at least one polydimethylsiloxane substituted quaternary ammonium with counterion.

In one embodiment the mixture of charge control agents consists of
i) at least one polydimethylsiloxane substituted primary amine and/or polydimethylsiloxane substituted secondary amine and/or polydimethylsiloxane substituted tertiary amine, and
ii) at least one polydimethylsiloxane substituted quaternary ammonium with counterion.

The term “counterion” in the meaning of the present invention refers to a monovalent or divalent anion, preferably a monovalent anion, that accompanies the at least one polydimethylsiloxane substituted quaternary ammonium in order to maintain electric neutrality. Preferably, the counterion is selected from halides or organic sulfates, more preferably the counterion is a halide or organic sulfate selected from the group consisting of iodide, bromide, chloride, methylsulfate anion, ethylsulfate anion, propylsulfate anion and butylsulfate anion.

Preferably, the mixture of charge control agents comprises the at least one polydimethylsiloxane substituted primary amine and/or polydimethylsiloxane substituted secondary amine and/or polydimethylsiloxane substituted tertiary amine of i) and the at least one polydimethylsiloxane substituted quaternary ammonium with counterion of ii) in a weight ratio [i)/ii)] ranging from 1:10 to 1:1.5, preferably from 1:8 to 1:1.8 and most preferably from 1:5 to 1:2.

The term “at least one” means that the polydimethylsiloxane substituted primary amine and/or polydimethylsiloxane substituted secondary amine and/or polydimethylsiloxane substituted tertiary amine comprises, preferably consists of, one or more polydimethylsiloxane substituted primary amine(s) and/or polydimethylsiloxane substituted secondary amine(s) and/or polydimethylsiloxane substituted tertiary amine(s).

In one embodiment, the at least one polydimethylsiloxane substituted primary amine and/or polydimethylsiloxane substituted secondary amine and/or polydimethylsiloxane substituted tertiary amine comprises, preferably consists of, one polydimethylsiloxane substituted primary amine or polydimethylsiloxane substituted secondary amine or polydimethylsiloxane substituted tertiary amine. Alternatively, the at least one polydimethylsiloxane substituted primary amine and/or polydimethylsiloxane substituted secondary amine and/or polydimethylsiloxane substituted tertiary amine comprises, preferably consists of, two or more polydimethylsiloxane substituted primary amine(s) and/or polydimethylsiloxane substituted secondary amine(s) and/or polydimethylsiloxane substituted tertiary amine(s). For example, the at least one polydimethylsiloxane substituted primary amine and/or polydimethylsiloxane substituted secondary amine and/or polydimethylsiloxane substituted tertiary amine comprises, preferably consists of, two or three polydimethylsiloxane substituted primary amine(s) and/or polydimethylsiloxane substituted secondary amine(s) and/or polydimethylsiloxane substituted tertiary amine(s). In other words, if the at least one polydimethylsiloxane substituted primary amine and/or polydimethylsiloxane substituted secondary amine and/or polydimethylsiloxane substituted tertiary amine comprises, preferably consists of, two or more polydimethylsiloxane substituted primary amine(s) and/or polydimethylsiloxane substituted secondary amine(s) and/or polydimethylsiloxane substituted tertiary amine(s), it preferably comprises, consists of, a mixture of different polydimethylsiloxane substituted primary amine(s) and/or polydimethylsiloxane substituted secondary amine(s) and/or polydimethylsiloxane substituted tertiary amine(s).

If the at least one polydimethylsiloxane substituted primary amine and/or polydimethylsiloxane substituted secondary amine and/or polydimethylsiloxane substituted tertiary amine is a mixture of different compounds, the mixture comprises, preferably consists of, two to five polydimethylsiloxane substituted primary amine(s) and/or polydimethylsiloxane substituted secondary amine(s) and/or polydimethylsiloxane substituted tertiary amine(s). For example, the mixture comprises, preferably consists of, two or three polydimethylsiloxane substituted primary amine(s) and/or polydimethylsiloxane substituted secondary amine(s) and/or polydimethylsiloxane substituted tertiary amine(s).

In one embodiment, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted primary amine and polydimethylsiloxane substituted secondary amine and polydimethylsiloxane substituted tertiary amine.

In an alternative embodiment, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted primary amine and polydimethylsiloxane substituted secondary amine or polydimethylsiloxane substituted tertiary amine. For example, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted primary amine and polydimethylsiloxane substituted secondary amine. For example, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted primary amine and polydimethylsiloxane substituted tertiary amine.

In an alternative embodiment, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted primary amine or polydimethylsiloxane substituted secondary amine and polydimethylsiloxane substituted tertiary amine. For example, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted secondary amine and polydimethylsiloxane substituted tertiary amine.

Especially good results are obtained if the at least one polydimethylsiloxane substituted primary amine and/or polydimethylsiloxane substituted secondary amine and/or polydimethylsiloxane substituted tertiary amine comprises a polydimethylsiloxane substituted tertiary amine. Thus, if the at least one polydimethylsiloxane substituted primary amine and/or polydimethylsiloxane substituted secondary amine and/or polydimethylsiloxane substituted tertiary amine is a mixture of compounds, the mixture preferably comprises, more preferably consists of, a polydimethylsiloxane substituted primary amine and polydimethylsiloxane substituted tertiary amine. Alternatively, the mixture comprises a polydimethylsiloxane substituted secondary amine and polydimethylsiloxane substituted tertiary amine. Alternatively, the mixture comprises, preferably consists of, a polydimethylsiloxane substituted primary amine and polydimethylsiloxane substituted secondary amine and polydimethylsiloxane substituted tertiary amine.

In one embodiment, the at least one polydimethylsiloxane substituted primary amine and/or polydimethylsiloxane substituted secondary amine and/or polydimethylsiloxane substituted tertiary amine comprises, more preferably consists of, one polydimethylsiloxane substituted primary amine or polydimethylsiloxane substituted secondary amine or polydimethylsiloxane substituted tertiary amine.

In view of the especially good results obtained with regard to the switching between the coloured and the transparent state, the at least one polydimethylsiloxane substituted primary amine and/or polydimethylsiloxane substituted secondary amine and/or polydimethylsiloxane substituted tertiary amine of i) is preferably a polydimethylsiloxane substituted tertiary amine.

It is appreciated that the at least one polydimethylsiloxane substituted primary amine and/or polydimethylsiloxane substituted secondary amine and/or polydimethylsiloxane substituted tertiary amine of i) is preferably a compound of the following Formula (IIa)

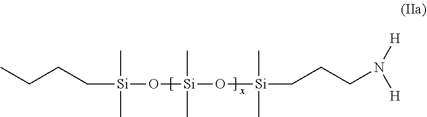

wherein x is an integer in the range from 5 to 20, and/or a compound of the following Formula (IIb)

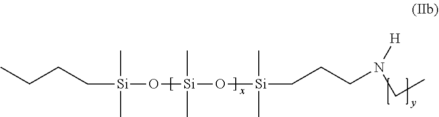

wherein x is an integer in the range from 5 to 20 and y is an integer in the range from 0 to 12, and/or a compound of the following Formula (IIc)

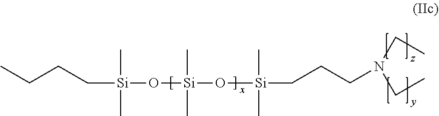

wherein x is an integer in the range from 5 to 20 and y and z are independently from each other and are integer in the range from 0 to 12.

For example, the at least one polydimethylsiloxane substituted primary amine of i) is preferably a compound of the following Formula (IIa),

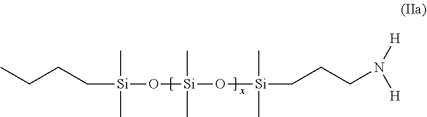

wherein x is an integer in the range from 7 to 17, preferably x is an integer in the range from 9 to 15, more preferably x is an integer in the range from 10 to 13 and most preferably x is 10 or 12.

Additionally or alternatively, the at least one polydimethylsiloxane substituted secondary amine of i) is preferably a compound of the following Formula (IIb)

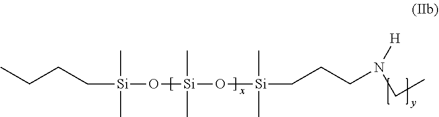

wherein x is an integer in the range from 7 to 17 and y is an integer in the range from 0 to 12, preferably x is an integer in the range from 9 to 15 and y is an integer in the range from 0 to 9, more preferably x is an integer in the range from 10 to 13 and y is an integer in the range from 0 to 7 and most preferably x is 10 or 12 and y is an integer in the range from 1 to 5, e.g. y is an integer in the range from 2 to 4 such as 3.

Additionally or alternatively, the at least one polydimethylsiloxane substituted tertiary amine of i) is preferably a compound of the following Formula (IIc)

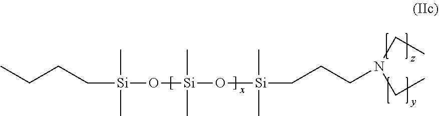

wherein x is an integer in the range from 7 to 17 and y and z are independently from each other and are an integer in the range from 0 to 12, preferably x is an integer in the range from 9 to 15 and y and z are independently from each other and are an integer in the range from 0 to 9, more preferably x is an integer in the range from 10 to 13 and y and z are independently from each other and are an integer in the range from 0 to 7 and most preferably x is 10 or 12 and y and z are independently from each other and are an integer in the range from 1 to 5, e.g. y and z are independently from each other and are an integer in the range from 2 to 4 such as 3.

Preferably, the at least one polydimethylsiloxane substituted primary amine and/or polydimethylsiloxane substituted secondary amine and/or polydimethylsiloxane substituted tertiary amine of i) is a compound of the Formula (IIc).

It is appreciated that the at least one polydimethylsiloxane substituted primary amine and/or polydimethylsiloxane substituted secondary amine and/or polydimethylsiloxane substituted tertiary amine of i) has a viscosity in the range from 5 to 15 mPas, preferably in the range from 8 to 12 mPas. The viscosity was determined by using a Brookfield viscometer; samples were maintained at 25° C.±2° C. during operation.

Furthermore, it is required that the mixture of charge control agents comprises at least one polydimethylsiloxane substituted quaternary ammonium with counterion.

The term “at least one” means that the polydimethylsiloxane substituted quaternary ammonium with counterion comprises, preferably consists of, one or more polydimethylsiloxane substituted quaternary ammonium(s) with counterion.

In one embodiment, the at least polydimethylsiloxane substituted quaternary ammonium with counterion comprises, preferably consists of, one polydimethylsiloxane substituted quaternary ammonium with counterion. Alternatively, the at least one polydimethylsiloxane substituted quaternary ammonium with counterion comprises, preferably consists of, two or more polydimethylsiloxane substituted quaternary ammonium(s) with counterion. For example, the at least one polydimethylsiloxane substituted quaternary ammonium with counterion comprises, preferably consists of, two or three polydimethylsiloxane substituted quaternary ammonium(s) with counterion. In other words, if the at least one polydimethylsiloxane substituted quaternary ammonium with counterion comprises, preferably consists of, two or more polydimethylsiloxane substituted quaternary ammoniums with counterion, the polydimethylsiloxane substituted quaternary ammonium with counterion comprises, preferably consists of, a mixture of different polydimethylsiloxane substituted quaternary ammonium(s) with counterion.

If the at least one polydimethylsiloxane substituted quaternary ammonium with counterion is a mixture of different compounds, the mixture comprises, preferably consists of, two to five polydimethylsiloxane substituted quaternary ammonium(s) with counterion. For example, the mixture comprises, preferably consists of, two or three polydimethylsiloxane substituted quaternary ammonium(s) with counterion.

Preferably, the at least one polydimethylsiloxane substituted quaternary ammonium with counterion is one polydimethylsiloxane substituted quaternary ammonium with counterion.

In one embodiment, the at least one polydimethylsiloxane substituted quaternary ammonium with counterion of ii) is a compound of the following Formula (III)

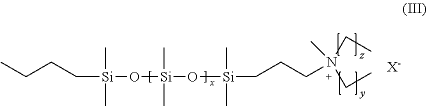

wherein x is an integer in the range from 5 to 20; y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

For example, the at least one polydimethylsiloxane substituted quaternary ammonium with counterion of ii) is a compound of the following Formula (Ill)

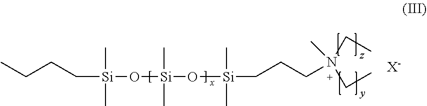

wherein x is an integer in the range from 7 to 17 and y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

Alternatively, the at least one polydimethylsiloxane substituted quaternary ammonium with counterion of ii) is a compound of the following Formula (III)

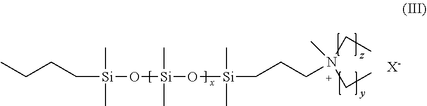

wherein x is an integer in the range from 9 to 15 and y and z are independently from each other and are an integer in the range from 0 to 9 and X⁻ is selected from the group consisting of iodide, bromide, chloride, methylsulfate anion, ethylsulfate anion, propylsulfate anion and butylsulfate anion.

Preferably, the at least one polydimethylsiloxane substituted quaternary ammonium with counterion of ii) is a compound of the following Formula (III)

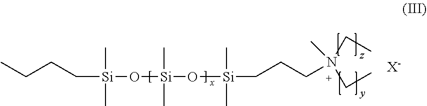

wherein x is an integer in the range from 10 to 13 and y and z are the same integer in the range from 0 to 7 and X⁻ is selected from the group consisting of iodide, bromide, chloride, methylsulfate anion, ethylsulfate anion, propylsulfate anion and butylsulfate anion.

For example, the at least one polydimethylsiloxane substituted quaternary ammonium with counterion of ii) is a compound of the following Formula (III)

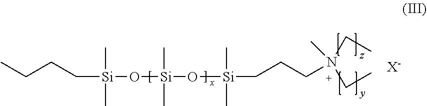

wherein x is 10 or 12 and y and z are the same integer in the range from 1 to 5, preferably y and z are the same integer in the range from 2 to 4, e.g. y and z are 3, and X⁻ is selected from the group consisting of iodide, bromide, chloride, methylsulfate anion, ethylsulfate anion, propylsulfate anion and butylsulfate anion.

In an alternative embodiment, the at least one polydimethylsiloxane substituted quaternary ammonium with counterion of ii) is a compound of the following Formula (IV)

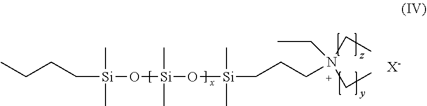

wherein x is an integer in the range from 5 to 20; y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

For example, the at least one polydimethylsiloxane substituted quaternary ammonium with counterion of ii) is a compound of the following Formula (IV)

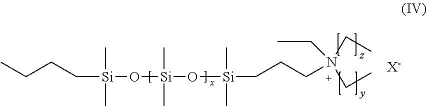

wherein x is an integer in the range from 7 to 17 and y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

Alternatively, the at least one polydimethylsiloxane substituted quaternary ammonium with counterion of ii) is a compound of the following Formula (IV)

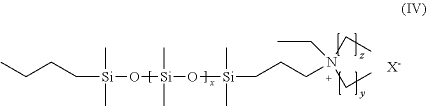

wherein x is an integer in the range from 9 to 15 and y and z are independently from each other and are an integer in the range from 0 to 9 and X⁻ is selected from the group consisting of iodide, bromide, chloride, methylsulfate anion, ethylsulfate anion, propylsulfate anion and butylsulfate anion.

Preferably, the at least one polydimethylsiloxane substituted quaternary ammonium with counterion of ii) is a compound of the following Formula (IV)

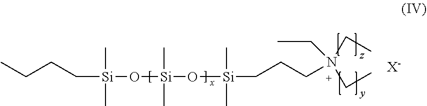

wherein x is an integer in the range from 10 to 13 and y and z are the same integer in the range from 0 to 7 and X⁻ is selected from the group consisting of iodide, bromide, chloride, methylsulfate anion, ethylsulfate anion, propylsulfate anion and butylsulfate anion.

For example, the at least one polydimethylsiloxane substituted quaternary ammonium with counterion of ii) is a compound of the following Formula (IV)

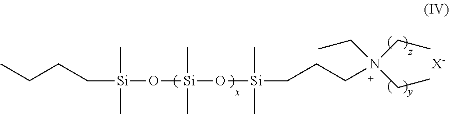

wherein x is 10 or 12 and y and z are the same integer in the range from 1 to 5, preferably y and z are the same integer in the range from 2 to 4, e.g. y and z are 3, and X⁻ is selected from the group consisting of iodide, bromide, chloride, methylsulfate anion, ethylsulfate anion, propylsulfate anion and butylsulfate anion.

It is appreciated that the at least one polydimethylsiloxane substituted quaternary ammonium with counterion of ii) has a viscosity in the range from 300 to 400 mPas, preferably in the range from 330 to 360 mPas. The viscosity was determined by using a Brookfield viscometer; samples were maintained at 25° C.±2° C. during operation.

Thus, it is preferred that the mixture of charge control agents comprises, preferably consists of,
i) at least one polydimethylsiloxane substituted primary amine and/or polydimethylsiloxane substituted secondary amine and/or polydimethylsiloxane substituted tertiary amine of the Formula (IIa) and/or Formula (IIb) and/or Formula (IIc)
and
ii) at least one polydimethylsiloxane substituted quaternary ammonium with counterion of the following Formula (III)

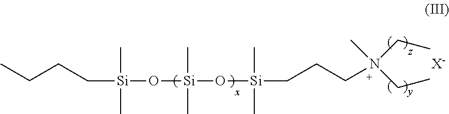

wherein x is an integer in the range from 5 to 20; y and z are independently from each other and are an integer in the range from 0 to 12 and X⁻ is selected from the group consisting of iodide, bromide, chloride, methylsulfate anion, ethylsulfate anion, propylsulfate anion and butylsulfate anion, or
iii) at least one polydimethylsiloxane substituted quaternary ammonium with counterion of the following Formula (IV)

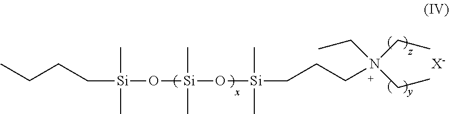

wherein x is an integer in the range from 5 to 20; y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

Preferably, the mixture of charge control agents comprises, preferably consists of,
i) at least one polydimethylsiloxane substituted tertiary amine of the following Formula (IIc)

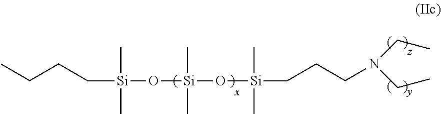

wherein x is an integer in the range from 7 to 17 and y and z are independently from each other and are an integer in the range from 0 to 12, and
ii) at least one polydimethylsiloxane substituted quaternary ammonium with counterion of the following Formula (III)

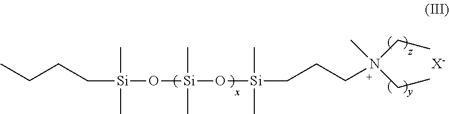

wherein x is an integer in the range from 7 to 17 and y and z are independently from each other and are an integer in the range from 0 to 12 and X⁻ is selected from the group consisting of iodide, bromide, chloride, methylsulfate anion, ethylsulfate anion, propylsulfate anion and butylsulfate anion, or
iii) at least one polydimethylsiloxane substituted quaternary ammonium with counterion of the following Formula (IV)

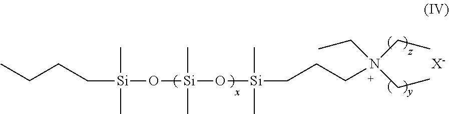

wherein x is an integer in the range from 7 to 17 and y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

Preferably, the mixture of charge control agents comprises, preferably consists of,
i) at least one polydimethylsiloxane substituted tertiary amine of the following Formula (IIc)

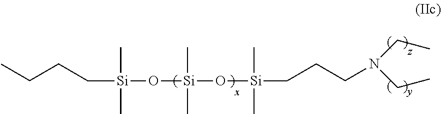

wherein x is an integer in the range from 9 to 15 and y and z are independently from each other and are an integer in the range from 0 to 9, and
ii) at least one polydimethylsiloxane substituted quaternary ammonium with counterion of the following Formula (III)

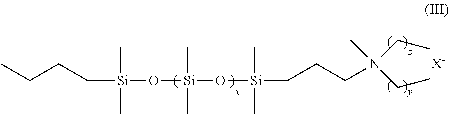

wherein x is an integer in the range from 9 to 15 and y and z are independently from each other and are an integer in the range from 0 to 9 and X⁻ is selected from the group consisting of iodide, bromide, chloride, methylsulfate anion, ethylsulfate anion, propylsulfate anion and butylsulfate anion, or
iii) at least one polydimethylsiloxane substituted quaternary ammonium with counterion of the following Formula (IV)

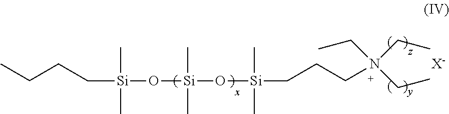

wherein x is an integer in the range from 9 to 15 and y and z are independently from each other and are an integer in the range from 0 to 9 and X⁻ is selected from the group consisting of iodide, bromide, chloride, methylsulfate anion, ethylsulfate anion, propylsulfate anion and butylsulfate anion.

More preferably, the mixture of charge control agents comprises, preferably consists of,
i) at least one polydimethylsiloxane substituted tertiary amine of the following Formula (IIc)

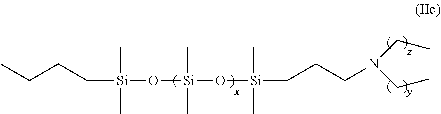

wherein x is an integer in the range from 10 to 13 and y and z are independently from each other and are an integer in the range from 0 to 7,
and
ii) at least one polydimethylsiloxane substituted quaternary ammonium with counterion of the following Formula (III)

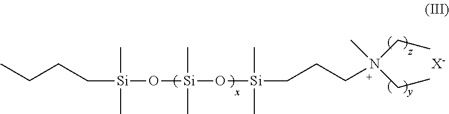

wherein x is an integer in the range from 10 to 13 and y and z are the same integer in the range from 0 to 7 and X⁻ is selected from the group consisting of iodide, bromide, chloride, methylsulfate anion, ethylsulfate anion, propylsulfate anion and butylsulfate anion, or
iii) at least one polydimethylsiloxane substituted quaternary ammonium with counterion of the following Formula (IV)

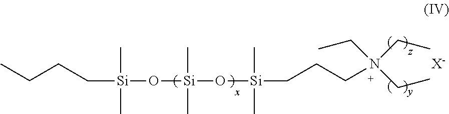

wherein x is an integer in the range from 10 to 13 and y and z are the same integer in the range from 0 to 7 and X⁻ is selected from the group consisting of iodide, bromide, chloride, methylsulfate anion, ethylsulfate anion, propylsulfate anion and butylsulfate anion.

Most preferably, the mixture of charge control agents comprises, preferably consists of,
i) at least one polydimethylsiloxane substituted tertiary amine of the following Formula (IIc)

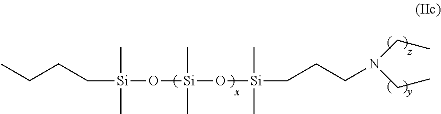

wherein x is 10 or 12 and y and z are independently from each other and are an integer in the range from 1 to 5, e.g. y and z are independently from each other and are an integer in the range from 2 to 4 such as 3, and
ii) at least one polydimethylsiloxane substituted quaternary ammonium with counterion of the following Formula (III)

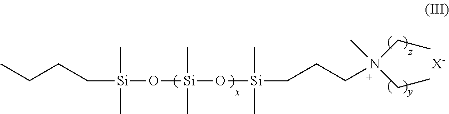

wherein x is 10 or 12 and y and z are the same integer in the range from 1 to 5, preferably y and z are the same integer in the range from 2 to 4, e.g. y and z are 3, and X⁻ is selected from the group consisting of iodide, bromide, chloride, methylsulfate anion, ethylsulfate anion, propylsulfate anion and butylsulfate anion, or
iii) at least one polydimethylsiloxane substituted quaternary ammonium with counterion of the following Formula (IV)

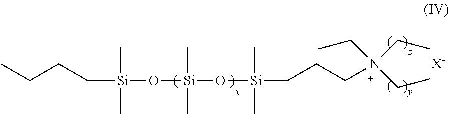

wherein x is 10 or 12 and y and z are the same integer in the range from 1 to 5, preferably y and z are the same integer in the range from 2 to 4, e.g. y and z are 3, and X⁻ is selected from the group consisting of iodide, bromide, chloride, methylsulfate anion, ethylsulfate anion, propylsulfate anion and butylsulfate anion.

As regards the mixture of charge control agents, it is preferred that x in Formula (IIc) and Formula (III) or Formula (IV) is the same and/or y in Formula (IIc) and Formula (III) or Formula (IV) is the same and/or z in Formula (IIc) and Formula (III) or Formula (IV) is the same. For example, x in Formula (IIc) and Formula (III) or Formula (IV) is the same and yin Formula (IIc) and Formula (III) or Formula (IV) is the same and z in Formula (IIc) and Formula (III) or Formula (IV) is the same. Alternatively, x in Formula (IIc) and Formula (III) or Formula (IV) is the same or y in Formula (IIc) and Formula (III) or Formula (IV) is the same or z in Formula (IIc) and Formula (III) or Formula (IV) is the same.

In one embodiment, x in Formula (IIc) and Formula (III) or Formula (IV) is the same or y in Formula (IIc) and Formula (III) or Formula (IV) is the same and z in Formula (IIc) and Formula (III) or Formula (IV) is the same.

It is especially preferred that y and z are the same in Formula (IIc) and Formula (III) or Formula (IV).

In one embodiment, the the mixture of charge control agents comprises, preferably consists of,
i) one polydimethylsiloxane substituted tertiary amine of the following Formula (IIc)

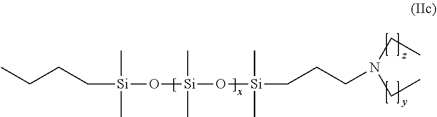

wherein x is 10 or 12 and y and z are independently from each other and are an integer in the range from 1 to 5, e.g. y and z are independently from each other and are an integer in the range from 2 to 4 such as 3, and
ii) one polydimethylsiloxane substituted quaternary ammonium with counterion of the following Formula (III)

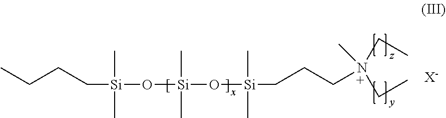

wherein x is 10 and y and z are the same integer in the range from 1 to 5, preferably y and z are the same integer in the range from 2 to 4, e.g. y and z are 3, and X⁻ is an iodide or methylsulfate anion, and/or
iii) one polydimethylsiloxane substituted quaternary ammonium with counterion of the following Formula (III)

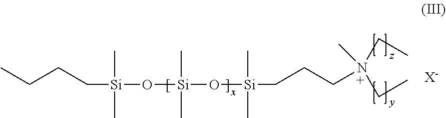

iv) wherein x is 12 and y and z are the same integer in the range from 1 to 5, preferably y and z are the same integer in the range from 2 to 4, e.g. y and z are 3, and X⁻ is an iodide or methylsulfate anion.

The electrophoretic ink comprises the mixture of charge control agents preferably in an amount of 5 to 40 wt.-%, more preferably in an amount of 10 to 30 wt.-%, based on the total weight of the electrophoretic ink.

For example, the electrophoretic ink comprises the mixture of charge control agents including the counterions in an amount of 5 to 40 wt.-%, more preferably in an amount of 10 to 30 wt.-%, based on the total weight of the electrophoretic ink.

In one embodiment, the electrophoretic ink comprises the at least one polydimethylsiloxane substituted primary amine and/or polydimethylsiloxane substituted secondary amine and/or polydimethylsiloxane substituted tertiary amine in an amount of 1 to 12 wt.-%, more preferably in an amount of 2 to 8 wt.-%, based on the total weight of the electrophoretic ink.

Additionally or alternatively, the electrophoretic ink comprises the at least one polydimethylsiloxane substituted quaternary ammonium with counterion in an amount of 5 to 17 wt.-%, more preferably in an amount of 7 to 15 wt.-%, based on the total weight of the electrophoretic ink.

It is appreciated that the amount of the at least one polydimethylsiloxane substituted quaternary ammonium with counterion in the electrophoretic ink is preferably above the amount of the at least one polydimethylsiloxane substituted primary amine and/or polydimethylsiloxane substituted secondary amine and/or polydimethylsiloxane substituted tertiary amine.

Preferably, the electrophoretic ink comprises the at least one polydimethylsiloxane substituted primary amine and/or polydimethylsiloxane substituted secondary amine and/or polydimethylsiloxane substituted tertiary amine of i) and the at least one polydimethylsiloxane substituted quaternary ammonium with counterion of ii) in a weight ratio [i)/ii)] ranging from 1:10 to 1:1.5, preferably from 1:8 to 1:1.8 and most preferably from 1:5 to 1:2.

The present invention further refers to a method for preparing an electrophoretic ink, the method comprising the steps of
a) providing at least one carrier fluid as defined herein,
b) providing pigment particles as defined herein,
c) optionally providing at least one dispersing agent as defined herein,
d) providing a mixture of charge control agents as defined herein, and
e) combining the at least one carrier fluid of step a), the pigment particles of step b), the optional dispersing agent of step c) and the mixture of charge control agents of step d).

The step of combining can be carried out with any conventional combining method known to the skilled person. For example, the combining can be carried out by mixing the at least one carrier fluid of step a), the pigment particles of step b), the optional dispersing agent of step c) and the mixture of charge control agents of step d).

In one embodiment, step e) is carried out by mixing and dispersing the components by using beads. The beads can be any beads known in the art for mixing and dispersing. Preferably, the beads are zirconium dioxide beads, more preferably zirconium dioxide beads having a particle size d₅₀ from 0.1 to 1 mm, such as from 0.2 to 0.8 mm.

In one embodiment, the method further comprises a step f) of combining the mixture obtained in step e) with a mixture comprising, preferably consisting of, at least one carrier fluid and a mixture of charge control agents. This step is advantageous in order to avoid the formation of pigment agglomerates.

The mixture comprising, preferably consisting of, at least one carrier fluid and a mixture of charge control agents comprises the mixture of charge control agents preferably in an amount ranging from 15 to 40 wt.-%, more preferably from 20 to 32 wt.-%, based on the total weight of the mixture. Accordingly, the mixture comprising, preferably consisting of, at least one carrier fluid and a mixture of charge control agents comprises the at least one carrier fluid preferably in an amount ranging from 60 to 85 wt.-%, more preferably from 68 to 80 wt.-%, based on the total weight of the mixture.

It is appreciated that the at least one carrier fluid in the mixture comprising, preferably consisting of, at least one carrier fluid and a mixture of charge control agents of step f) and the at least one carrier fluid provided in step a) are preferably the same.

Additionally or alternatively, the mixture of charge control agents in the mixture comprising, preferably consisting of, at least one carrier fluid and a mixture of charge control agents of step f) and the mixture of charge control agents provided in step d) are preferably the same.

If the method comprises step f), the mixture obtained in step e) and the mixture comprising, preferably consisting of, at least one carrier fluid and a mixture of charge control agents are preferably combined in a weight ratio [mixture obtained in step e)/mixture added in step f)] ranging from 5:1 to 1:1, preferably from 3:1 to 1:1 and most preferably from 2:1 to 1:1.

The present invention is further directed to an electrophoretic display comprising
a) a top layer and a bottom layer, wherein at least one is transparent, and
b) an array of cells sandwiched between the top layer and the bottom layer and the cells are at least partially filled with the electrophoretic ink as defined herein.

Furthermore, the present invention is directed to an electrophoretic smart window comprising
a) a top layer and a bottom layer, wherein at least one is transparent, and
b) an array of cells sandwiched between the top layer and the bottom layer and the cells are at least partially filled with the electrophoretic ink as defined herein.

In a preferred embodiment, the top layer and the bottom layer are transparent.

The electrophoretic display or smart window can be of any conventional arrangement known to the skilled person for electrophoretic displays or smart windows.

Advantageous arrangements of electrophoretic displays or smart windows are displayed in FIGS. 1 to 4.

For example, the top layer and the bottom layer of the electrophoretic display or smart window cell are electrically conducting layers, e.g. by using one or more layers of indium tin oxide (ITO). Preferably, the top layer and the bottom layer are transparent, more preferably the top layer and the bottom layer are made of ITO coated glass. Thus, the top layer and the bottom layer are preferably electrically conducting layers and transparent, e.g. made of ITO coated glass (see e.g. FIGS. 1 to 5). It is appreciated that the display cell is arranged such that it includes a reflective layer is fixed to the ITO coated glass bottom layer (see FIGS. 1 and 4). In contrast thereto, the smart window cell is free of a reflective layer fixed to the ITO coated glass bottom layer (see FIGS. 2 and 5).

The top layer and the bottom layer of the electrophoretic display or smart window cell are preferably arranged such that they are separated by spacers (see e.g. FIGS. 1 to 5). The formed cells are preferably at least partially filled with the electrophoretic ink as defined herein.

In one embodiment, the top layer and the bottom layer of the electrophoretic display or smart window cell are thus ITO coated glass and are separated by spacers.

In one embodiment of the electrophoretic display, two or more display cells are stacked on each other. In this arrangement, the cells are preferably joined to each other, i.e. the bottom layer of one cell to the top layer of another cell, by a binder layer (see e.g. FIG. 4). Preferably, each cell is at least partially filled with the same or different black or coloured electrophoretic ink, preferably coloured electrophoretic ink.

In an alternative embodiment, a single display cell is provided. In this arrangement, the cell is preferably at least partially filled with a black or coloured electrophoretic ink.

In one embodiment of the smart window, two or more display cells are stacked on each other. In this arrangement, the cells are preferably joined to each other, i.e. the bottom layer of one cell is joined to the top layer of another cell, by a binder layer (see e.g. FIG. 5). Preferably, each cell is at least partially filled with the same or different black or coloured electrophoretic ink, preferably coloured electrophoretic ink.

In an alternative embodiment, a single smart window cell is provided. In this arrangement, the cell is preferably at least partially filled with the black or coloured electrophoretic ink.

In view of the very good results obtained, the present invention is also directed to the use of an electrophoretic ink, as defined herein, in electrophoretic displays or smart windows.

The invention also relates to the use of a mixture of charge control agents, as defined herein, for the preparation of an electrophoretic ink.

As regards the electrophoretic ink and the mixture of charge control agents, it is referred to the comments provided above when defining the electrophoretic ink, the mixture of charge control agents and embodiments thereof in more detail.

The scope and interest of the invention will be better understood based on the following examples which are intended to illustrate certain embodiments of the invention and are non-limitative.

### BRIEF DESCRIPTION OF FIGURES

FIG. 1 refers to a schematic illustration of a display cell containing a black or coloured electrophoretic ink.

FIG. 2 refers to a schematic illustration of a smart window cell containing a black or coloured electrophoretic ink.

FIG. 3 refers to a schematic illustration of a display or smart window cell viewed from above.

FIG. 4 refers to a schematic illustration of stacked display cells containing coloured electrophoretic inks.

FIG. 5 refers to a schematic illustration of stacked smart window cells containing coloured electrophoretic inks.

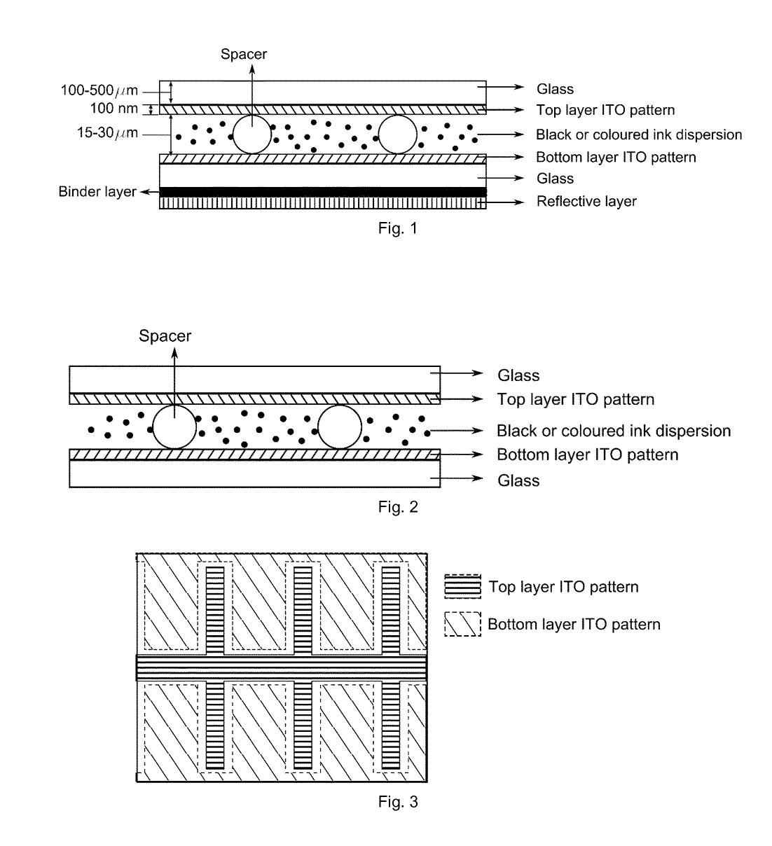

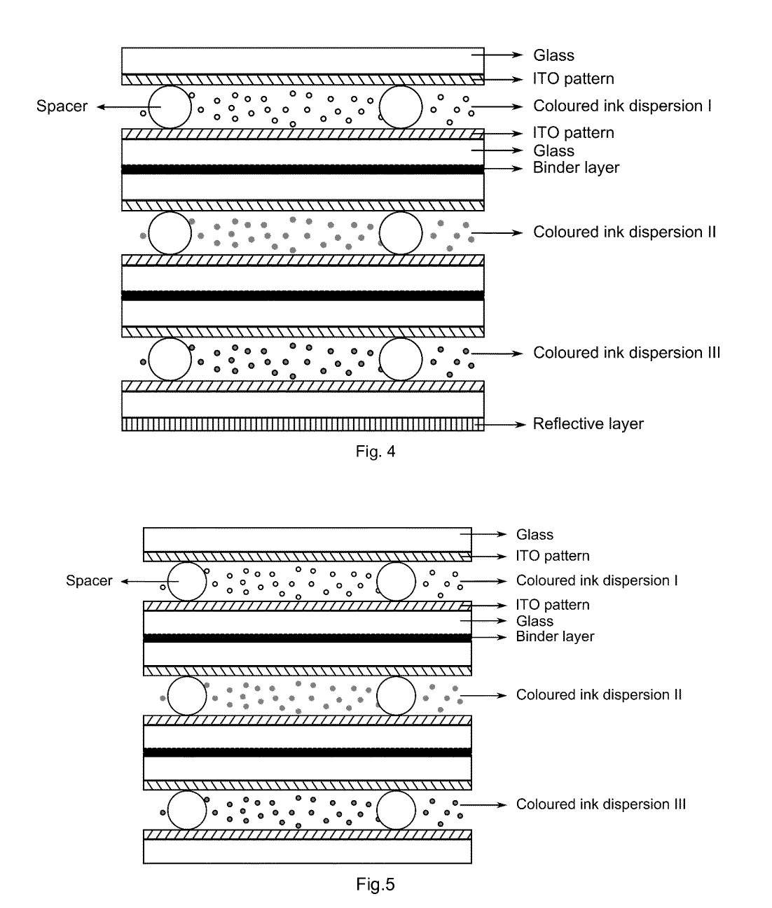

### EXAMPLES

### 1. Preparation of Charge Control Agents (CCAs)

### 1.1 Allyldialkylamine

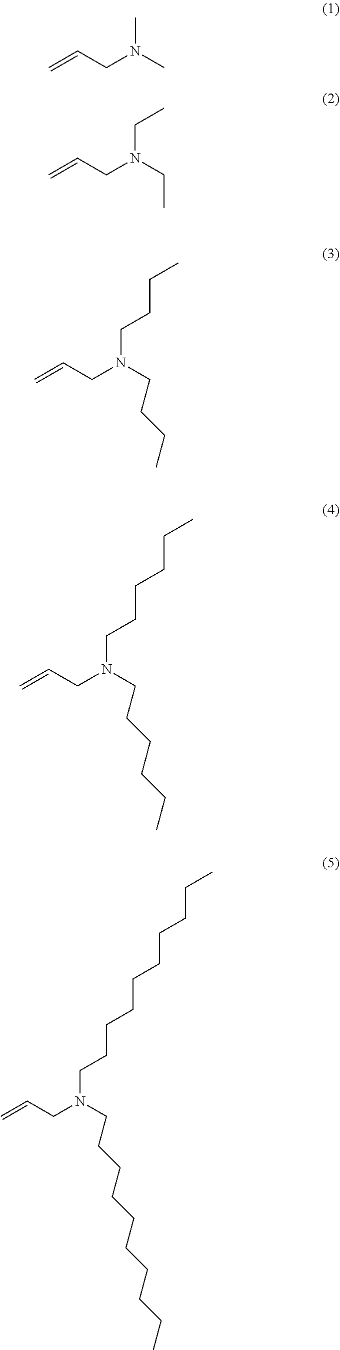

Compound (1) is commercially available from Sigma-Aldrich. Compound (2) is synthesized as described in 1.1.1. Compounds (3), (4), and (5) are synthesized as described in 1.1.2.

### 1.1.1 Allyldiethylamine

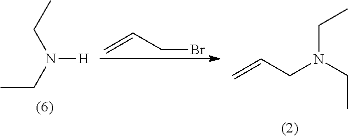

6 g of compound (6) (Fluke) is dissolved in 40 g of deionized water. 10 g of allylbromide (Sigma-Aldrich) is added to the solution. The pH value of the reaction mixture is adjusted to 10.7 by adding 32 mL of NaOH solution (10%). The mixture is stirred for 5.5 hours at 80° C. After cooling to ambient temperature, an organic phase is separated from the reaction mixture and the residual aqueous phase is removed. The obtained organic phase is washed twice with water (Nanopur) and dried in a rotary evaporator at 60° C. in vacuo, leaving 2.1 g of a crude product.

The crude product is distilled at 80° C. in vacuo, resulting in 1.6 g of allyldiethylamine (compound (2)) according to ¹H- or ¹³C-NMR.

### 1.1.2 Allyldibutylamine, Allyldihexylamine, and Allyldidecylamine

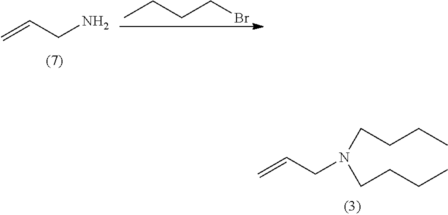

80.0 g of compound (7) and 494.1 g of n-butyl bromide are added to 600 g of deionized water. The pH value of the reaction mixture is adjusted to 10.7 by adding 314.9 g of NaOH solution (30%). The mixture is stirred for 7 hours at 95° C. After cooling to ambient temperature, the mixture is stirred overnight for ca. 16.5 hours. After that, the pH value of the mixture is adjusted to 10.7 by adding 131.7 g of NaOH solution (30%). The mixture is stirred for 7 hours at 99° C. After cooling to ambient temperature, the mixture is stirred overnight for ca. 16 hours. An organic phase is separated from the reaction mixture and washed with deionized water. The organic phase is distilled initially at 75° C. and then at 85° C. in vacuo, resulting in 180.0 g of allyldibutylamine (compound (3)) according to ¹H- and ¹³C-NMR.

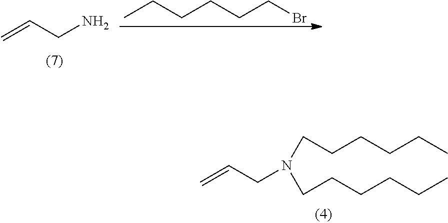

58.3 g of compound (7) and 437.9 g of n-hexyl bromide are added to 437 g of deionized water. The pH value of the reaction mixture is adjusted to 10.7 by adding 259.8 g of NaOH solution (30%). The mixture is stirred for 8 hours at 95° C. After cooling to ambient temperature, the mixture is stirred overnight for ca. 16 hours. After that, the pH value of the mixture is adjusted to 10.7 by adding 75.8 g of NaOH solution (30%). The mixture is stirred for 6 hours at 97° C. After cooling to ambient temperature, an organic phase is separated from the reaction mixture and washed with deionized water. The organic phase is distilled initially at 70° C. and then at 120° C. in vacuo, resulting in 169.5 g of allyldihexylamine (compound (4)) according to ¹H- and ¹³C-NMR.

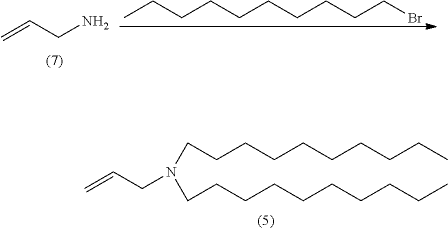

46.6 g of compound (7) and 470.0 g of n-decyl bromide are added to 350 g of deionized water. The pH value of the reaction mixture is adjusted to 10.7 by adding 116.3 g of NaOH solution (30%). The mixture is stirred for 7.5 hours at 95° C. After cooling to ambient temperature, the mixture is stirred overnight for ca. 16 hours. After that, the pH value of the mixture is adjusted to 10.7 by adding 119.7 g of NaOH solution (30%). The mixture is stirred for 6.5 hours at 97° C.

After cooling to ambient temperature, an organic phase is separated from the reaction mixture and is first washed with deionized water, then with NaCl solution (20%). The organic phase is distilled initially at 70° C. and then at 160° C. in vacuo, resulting in 160.3 g of allyldidecylamine (compound (5)) according to ¹H- and ¹³C-NMR.

### 1.2 N,N-dialkylamino-propyl-polydimethylsiloxane

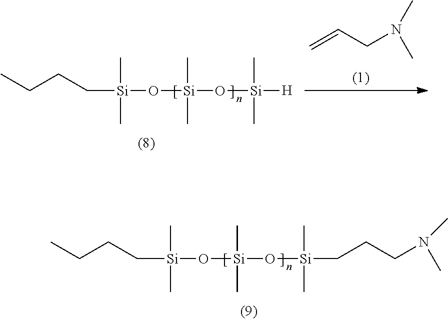

A solution of 0.025 g of hexachloroplatinic acid in 1 mL of tetrahydrofuran is added to 50.0 g of compound (8) (ABCR), a linear poly(dimethylsiloxane) terminated by a butyl group at one end and a hydride at the other end with a viscosity of 5-9 cSt (i.e. n is about 10). The mixture is heated to 90° C. in a reactor with nitrogen as protective gas. 4.35 g of allyldimethylamine (compound (1), Sigma-Aldrich) is added by drop to the mixture under stirring; the process is finished within 30 minutes. The reaction mixture is stirred for 2 hours at 90° C. and then cooled down to 60° C. 1.0 g of active carbon (Norit Azo) is added to the reaction mixture. After stirring for 2 hours, the mixture is filtered through diatomaceous earth (Clarcel DIC), resulting in 50.8 g of compound (9) according to ¹H- and ¹³C-NMR.

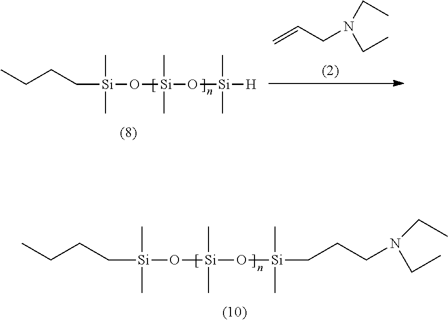

A solution of 0.008 g of hexachloroplatinic acid in 1 mL of tetrahydrofuran is added to 13.0 g of compound (8) (ABCR), a linear poly(dimethylsiloxane) terminated by a butyl group at one end and a hydride at the other end with a viscosity of 5-9 cSt (i.e. n is about 10). The mixture is heated to 90° C. in a reactor with nitrogen as protective gas. 1.50 g of allyldiethylamine (compound (2)) is added by drop to the mixture under stirring; the process is finished within 30 minutes. The reaction mixture is stirred for 2.5 hours at 90° C. and then cooled down to 60° C. 0.26 g of active carbon (Norit Azo) is added to the reaction mixture. After stirring for 2 hours, the mixture is filtered through diatomaceous earth (Clarcel DIC), resulting in 10.9 g of compound (10) according to ¹H- and 13C-NMR.

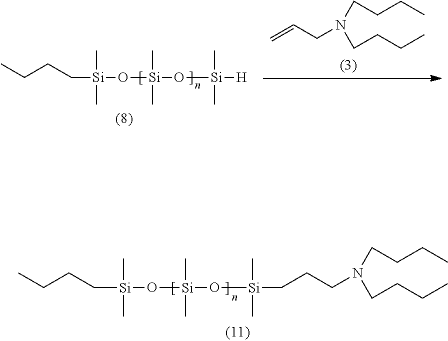

A solution of 0.040 g of hexachloroplatinic acid in 1 mL of tetrahydrofuran is added to 500.0 g of compound (8) (ABCR), a linear poly(dimethylsiloxane) terminated by a butyl group at one end and a hydride at the other end with a viscosity of 5-9 cSt (i.e. n is about 10). The mixture is heated to 90° C. in a reactor with nitrogen as protective gas. 87.30 g of allyldibutylamine (compound (3)) is added by drop to the mixture under stirring; the process is finished within 30 minutes. The reaction mixture is stirred for 1 hour at 90° C. and then cooled down to 60° C. 10.0 g of active carbon (Norit Azo) is added to the reaction mixture. After stirring for 2 hours, the mixture is filtered through diatomaceous earth (Clarcel DIC), resulting in 561.1 g of compound (11) according to ¹H- and ¹³C-NMR.

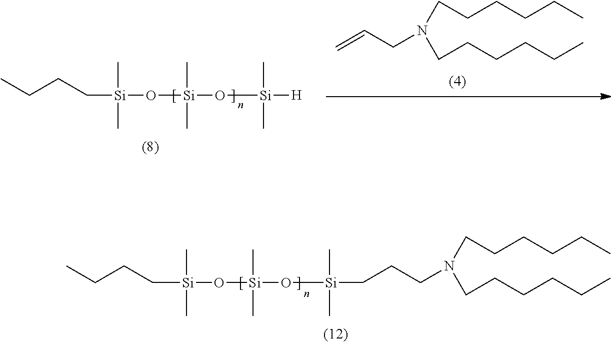

A solution of 0.025 g of hexachloroplatinic acid in 1 mL of tetrahydrofuran is added to 50.0 g of compound (8) (ABCR), a linear poly(dimethylsiloxane) terminated by a butyl group at one end and a hydride at the other end with a viscosity of 5-9 cSt (i.e. n is about 10). The mixture is heated to 90° C. in a reactor with nitrogen as protective gas. 11.50 g of allyldihexylamine (compound (4)) is added by drop to the mixture under stirring; the process is finished within 30 minutes. The reaction mixture is stirred for 1 hour at 90° C. and then cooled down to 60° C. 1.0 g of active carbon (Norit Azo) is added to the reaction mixture. After stirring for 2 hours, the mixture is filtered through diatomaceous earth (Clarcel DIC), resulting in 57.7 g of compound (12) according to ¹H- and ¹³C-NMR.

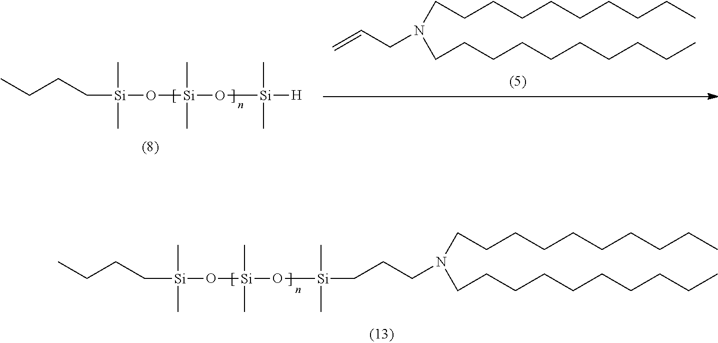

A solution of 0.025 g of hexachloroplatinic acid in 1 mL of tetrahydrofuran is added to 50.0 g of compound (8) (ABCR), a linear poly(dimethylsiloxane) terminated by a butyl group at one end and a hydride at the other end with a viscosity of 5-9 cSt (i.e. n is about 10). The mixture is heated to 90° C. in a reactor with nitrogen as protective gas. 17.24 g of allyldidecylamine (compound (5)) is added by drop to the mixture under stirring; the process is finished within 30 minutes. The reaction mixture is stirred for 1 hour at 90° C. and then cooled down to 60° C. 1.0 g of active carbon (Norit Azo) is added to the reaction mixture. After stirring for 2 hours, the mixture is filtered through diatomaceous earth (Clarcel DIC), resulting in 62.0 g of compound (13) according to ¹H- and ¹³C-NMR.

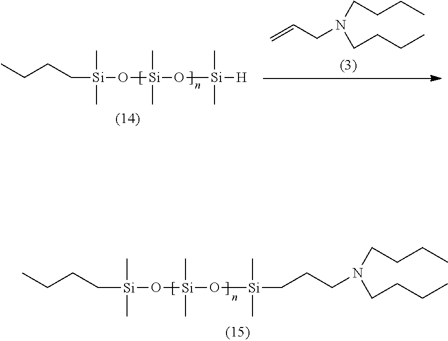

A solution of 0.030 g of hexachloroplatinic acid in 1 mL of tetrahydrofuran is added to 84.0 g of compound (14) (Gelest), a linear poly(dimethylsiloxane) terminated by a butyl group at one end and a hydride at the other end with a viscosity of 10-15 cSt (i.e. n is about 12). The mixture is heated to 90° C. in a reactor with nitrogen as protective gas. 12.20 g of allyldibutylamine (compound (3)) is added by drop to the mixture under stirring; the process is finished within 30 minutes. The reaction mixture is stirred for 1.5 hours at 90° C. and then cooled down to 60° C. 2.0 g of active carbon (Norit Azo) is added to the reaction mixture. After stirring for 1 hours, the mixture is filtered through diatomaceous earth (Clarcel DIC), resulting in 90.4 g of compound (15) according to ¹H- and ¹³C-NMR.

### 1.3 Methyl-dialkyl-ammoniumpropyl-polydimethylsiloxane

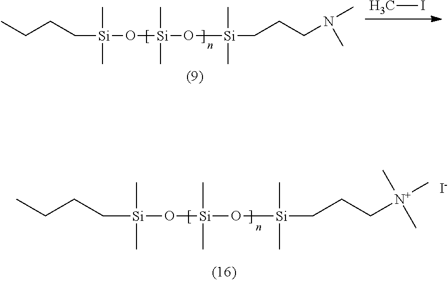

2.55 g of methyl iodide is added to 20.0 g of compound (9), and this mixture is stirred for 3 hours at 43° C. The reaction mixture is diluted with dichloromethane and another 1.30 g of methyl iodide is added to it. The reaction mixture is stirred for 2 hours at 43° C. After cooling to ambient temperature, the excess of methyl iodide and dichloromethane is removed in vacuo, leaving behind 20.6 g of compound (16) according to ¹H-NMR.

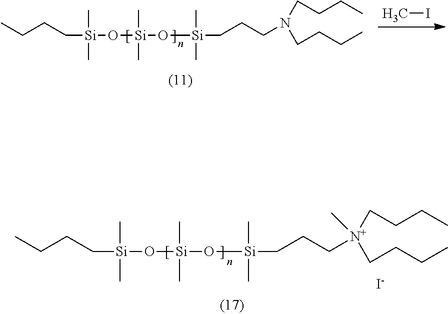

366.0 g of methyl iodide is added to 806.5 g of compound (11), and this process is finished within 30 minutes. The reaction mixture is stirred at 43° C. After adding methyl iodide, complete conversion of compound (11) is achieved according to¹H-NMR. The mixture is cooled to ambient temperature and the excess of methyl iodide is removed in vacuo, leaving behind 909.9 g of compound (17).

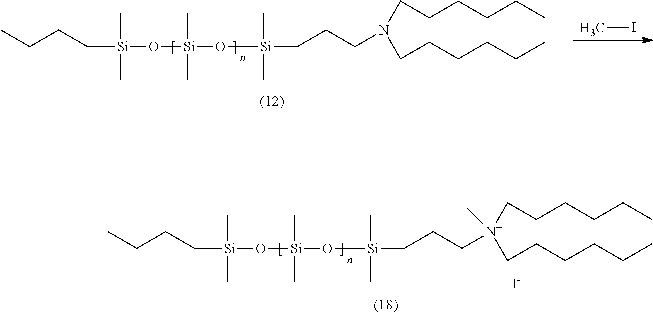

3.38 g of methyl iodide is added to 20.0 g of compound (12), and this process is finished within 10 minutes. The reaction mixture is stirred for 5 hours at 43° C. After cooling to ambient temperature, the excess of methyl iodide and is removed in vacuo, leaving behind 19.8 g of compound (18) according to ¹H-NMR.

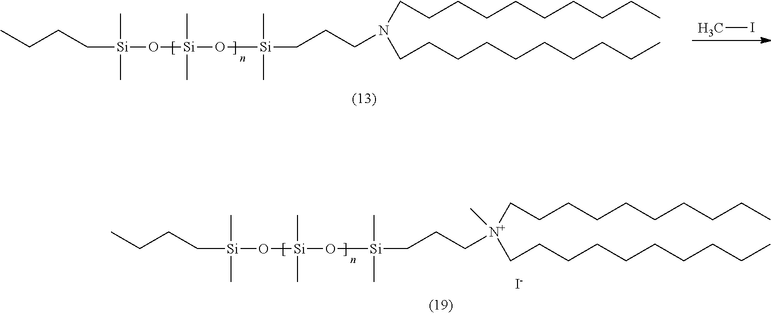

3.10 g of methyl iodide is added to 20.0 g of compound (13), and this process is finished within 10 minutes. The reaction mixture is stirred for 5 hours at 42° C. After cooling to ambient temperature, the excess of methyl iodide is removed in vacuo, leaving behind 20.8 g of compound (19) according to ¹H-NMR.

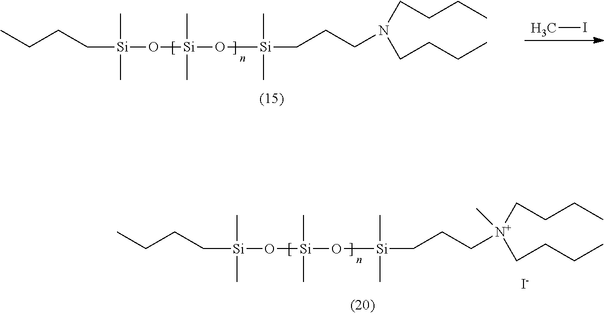

14.6 g of methyl iodide is added to 100.0 g of compound (15), and this process is finished within 30 minutes. The reaction mixture is stirred for 5 hours at 42° C. After cooling to ambient temperature, the excess of methyl iodide is removed in vacuo, leaving behind 109.3 g of compound (20) according to ¹H-NMR.

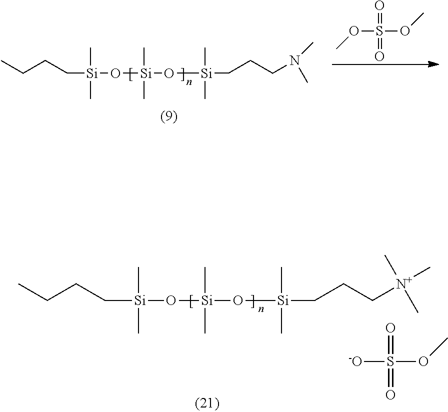

2.36 g of dimethyl sulfate is added to 20.0 g of compound (9), and the reaction mixture is diluted with 5 g of dichloromethane. The reaction mixture is stirred for 2 hours at 42° C. After cooling to ambient temperature, compound (9) and dimethyl sulfate are completely conversed, and dichloromethane is removed in vacuo, leaving behind 22.0 g of compound (21) according to¹H-NMR.

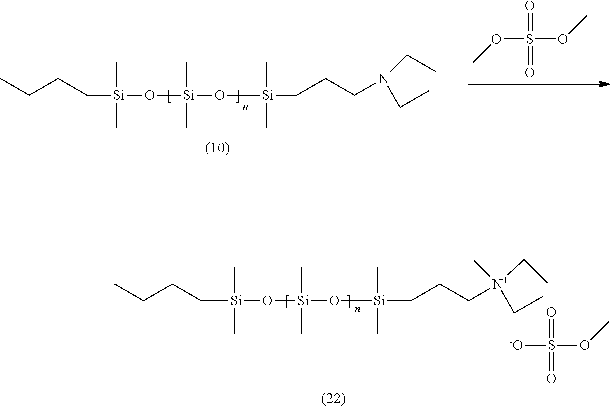

0.23 g of dimethyl sulfate is added to 2.0 g of compound (10), the reaction mixture is stirred for 30 minutes at 42° C. Compound (10) and dimethyl sulfate are completely conversed, leaving behind 2.1 g of compound (22) according to ¹H-NMR.

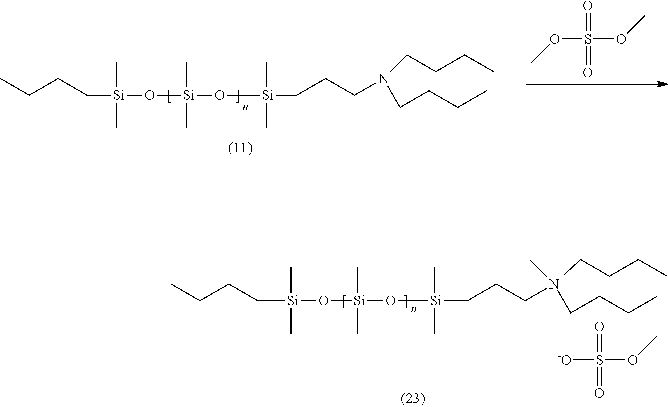

7.30 g of dimethyl sulfate is added to 75.0 g of compound (11), the reaction mixture is stirred for 5 hours at 42° C. Compound (11) and dimethyl sulfate are completely conversed, leaving behind 81.3 g of compound (23) according to ¹H-NMR.

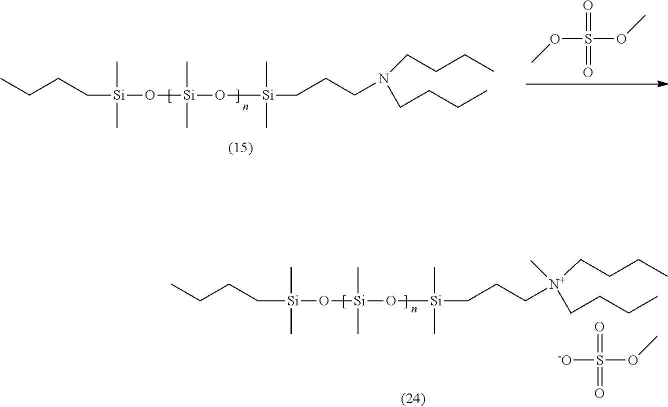

7.20 g of dimethyl sulfate is added to 89.9 g of compound (15), the reaction mixture is stirred for 5 hours at 42° C. Compound (15) and dimethyl sulfate are completely conversed, leaving behind 95.9 g of compound (24) according to ¹H-NMR.

### 1.4 Ethyl-dialkyl-ammoniumpropyl-polydimethylsiloxane

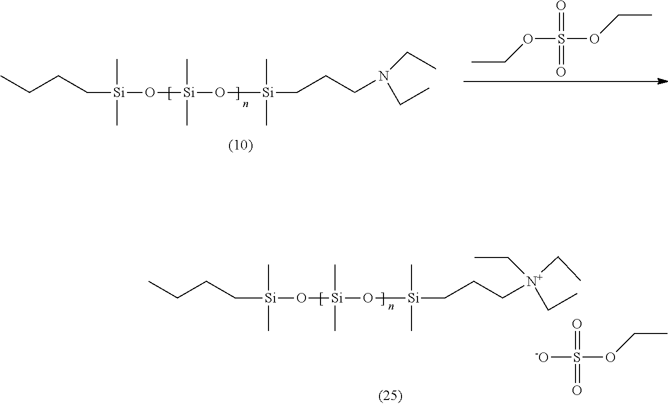

0.28 g of diethyl sulfate is added to 2.0 g of compound (10), the reaction mixture is stirred first for 3 hours at 60° C. and then for 2 hours 20 minutes at 80° C. Compound (10) and diethyl sulfate are completely conversed, leaving behind 2.1 g of compound (25) according to ¹H-NMR.

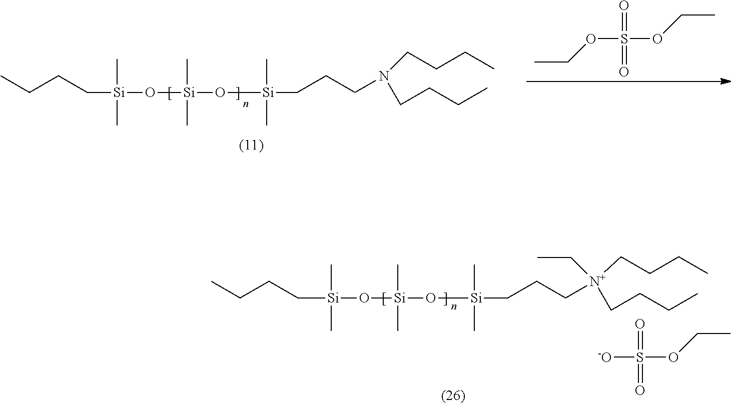

2.66 g of diethyl sulfate is added to 20.0 g of compound (11), the reaction mixture is stirred for 3 hours at 99° C. Compound (11) and diethyl sulfate are completely conversed, leaving behind 21.5 g of compound (26) according to ¹H-NMR.

### 2. Electrophoretic Ink Dispersion Comprising Black Pigment Particles

### 2.1 Initial Formulation of Electrophoretic Ink Dispersion Comprising Black Pigment Particles

0.5 g of N,N-dialkylamino-propyl-polydimethylsiloxane as described in 1.2 (one or more examples selected from compound (9), (10), (11), (12), (13), and/or (15)) and 1.0 g of methyl-dialkyl-ammoniumpropyl-polydimethylsiloxane as described in 1.3 (one or more examples selected from compound (16), (17), (18), (19), (20), (21), (22), (23), and/or (24)) or 1.0 g of ethyl-dialkyl-ammoniumpropyl-polydimethylsiloxane as described in 1.4 (compound (25) or (26) or their mixture) are dissolved in 7.95 g of carrier fluid (one or more examples selected from alkanes, halogenated or partially halogenated alkanes, and/or siloxanes), resulting in a charge control agent solution. 0.5 g of black pigment particles (compound (27) or (28) or their mixture) and 0.05 g of dispersant (compound (29)) are added to the charge control agent solution. The mixture is dispersed with 50 g of zirconium dioxide beads (diameter: 0.5 mm) for 30 hours in a vial set in a Skandex shaker.

### 2.2 Final Formulation of Electrophoretic Ink Dispersion Comprising Black Pigment Particles

30 mg of N,N-dialkylamino-propyl-polydimethylsiloxane as described in 1.2 (one or more examples selected from compound (9), (10), (11), (12), (13), and/or (15)) and 80 mg of methyl-dialkyl-ammoniumpropyl-polydimethylsiloxane as described in 1.3 (one or more examples selected from compound (16), (17), (18), (19), (20), (21), (22), (23), and/or (24)) or 80 mg of ethyl-dialkyl-ammoniumpropyl-polydimethylsiloxane as described in 1.4 (compound (25) or (26) or their mixture) are dissolved in 290 mg of carrier fluid (one or more examples selected from alkanes, halogenated or partially halogenated alkanes, and/or siloxanes), resulting in a charge control agent solution. 600 mg of electrophoretic ink dispersion as described in 2.1 is added to the charge control agent solution. The mixture is dispersed with 1 g of zirconium dioxide beads (diameter: 0.5 mm) for 15 hours in a vial set in a Skandex shaker.

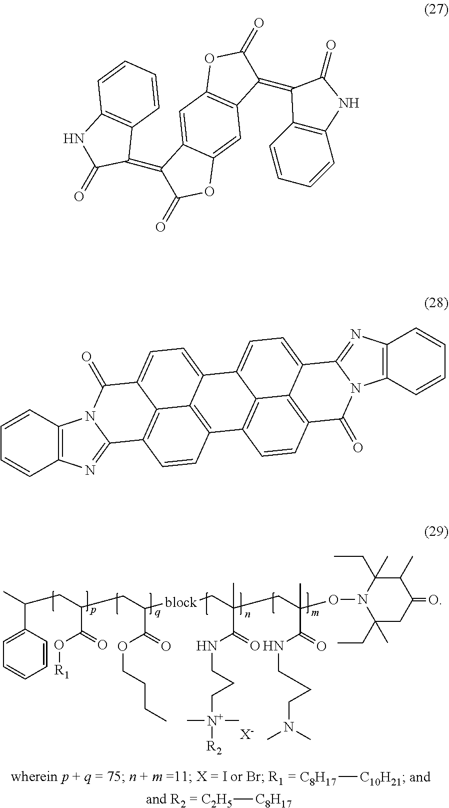

### 2.3 Switching-Test of Electrophoretic Ink Dispersion Comprising Black Pigment Particles

A droplet of the electrophoretic ink dispersion comprising black pigment particles as described in 2.2 is spread on a glass substrate with an ITO (indium tin oxide) pattern consisting of two series of oppositely charged electrodes with 30-60 μm gap in-between and covered with a cover glass. The thickness of the liquid layer is controlled by a spherical spacer material (diameter: 15 μm). The ITO substrate is driven with 20V, 40V, 60V, or 80V block wave with a frequency of 1.0 Hz. The pigment particles switch between electrodes under the above mentioned driving conditions.

### 3. Electrophoretic Ink Dispersion Comprising Cyan Pigment Particles

### 3.1 Initial Formulation of Electrophoretic Ink Dispersion Comprising Cyan Pigment Particles

0.5 g of N,N-dialkylamino-propyl-polydimethylsiloxane as described in 1.2 (one or more examples selected from compound (9), (10), (11), (12), (13), and/or (15)) and 1.0 g of methyl-dialkyl-ammoniumpropyl-polydimethylsiloxane as described in 1.3 (one or more examples selected from compound (16), (17), (18), (19), (20), (21), (22), (23), and/or (24)) or 1.0 g of ethyl-dialkyl-ammoniumpropyl-polydimethylsiloxane as described in 1.4 (compound (25) or (26) or their mixture) are dissolved in 7.9 g of carrier fluid (one or more examples selected from alkanes, halogenated or partially halogenated alkanes, and/or siloxanes), resulting in a charge control agent solution. 0.5 g of cyan pigment particles (compound (30) or (31) or their mixture), 0.05 g of Solsperse 5000, and 0.05 g of dispersant (compound (29)) are added to the charge control agent solution. The mixture is dispersed with 50 g of zirconium dioxide beads (diameter:

0.5 mm) for 30 hours in a vial set in a Skandex shaker.

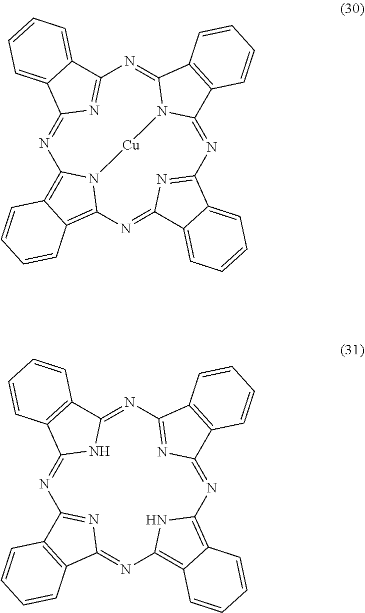

### 3.2 Final Formulation of Electrophoretic Ink Dispersion Comprising Cyan Pigment Particles

30 mg of N,N-dialkylamino-propyl-polydimethylsiloxane as described in 1.2 (one or more examples selected from compound (9), (10), (11), (12), (13), and/or (15)) and 80 mg of methyl-dialkyl-ammoniumpropyl-polydimethylsiloxane as described in 1.3 (one or more examples selected from compound (16), (17), (18), (19), (20), (21), (22), (23), and/or (24)) or 80 mg of ethyl-dialkyl-ammoniumpropyl-polydimethylsiloxane as described in 1.4 (compound (25) or (26) or their mixture) are dissolved in 290 mg of carrier fluid (one or more examples selected from alkanes, halogenated or partially halogenated alkanes, and/or siloxanes), resulting in a charge control agent solution. 600 mg of electrophoretic ink dispersion as described in 3.1 is added to the charge control agent solution. The mixture is dispersed with 1 g of zirconium dioxide beads (diameter: 0.5 mm) for 15 hours in a vial set in a Skandex shaker.

### 3.3 Switching-Test of Electrophoretic Ink Dispersion Comprising Cyan Pigment Particles

A droplet of the electrophoretic ink dispersion comprising cyan pigment particles as described in 3.2 is spread on a glass substrate with an ITO (indium tin oxide) pattern consisting of two series of oppositely charged electrodes with 30-60 μm gap in-between and covered with a cover glass. The thickness of the liquid layer is controlled by a spherical spacer material (diameter: 15 μm).

The ITO substrate is driven with 20V, 40V, 60V, or 80V block wave with a frequency of 1.0 Hz. The pigment particles switch between electrodes under the above mentioned driving conditions.

### 4. Electrophoretic Ink Dispersion Comprising Magenta Pigment Particles

### 4.1 Initial Formulation of Electrophoretic Ink Dispersion Comprising Magnetic Pigment Particles

0.5 g of N,N-dialkylamino-propyl-polydimethylsiloxane as described in 1.2 (one or more examples selected from compound (9), (10), (11), (12), (13), and/or (15)) and 1.0 g of methyl-dialkyl-ammoniumpropyl-polydimethylsiloxane as described in 1.3 (one or more examples selected from compound (16), (17), (18), (19), (20), (21), (22), (23), and/or (24)) or 1.0 g of ethyl-dialkyl-ammoniumpropyl-polydimethylsiloxane as described in 1.4 (compound (25) or (26) or their mixture) are dissolved in 7.95 g of carrier fluid (one or more examples selected from alkanes, halogenated or partially halogenated alkanes, and/or siloxanes), resulting in a charge control agent solution. 0.5 g of magenta pigment particles (one or more examples selected from compound (32), (33), and/or (34)) and 0.05 g of dispersant (compound (29)) are added to the charge control agent solution. The mixture is dispersed with 50 g of zirconium dioxide beads (diameter: 0.5 mm) for 30 hours in a vial set in a Skandex shaker.

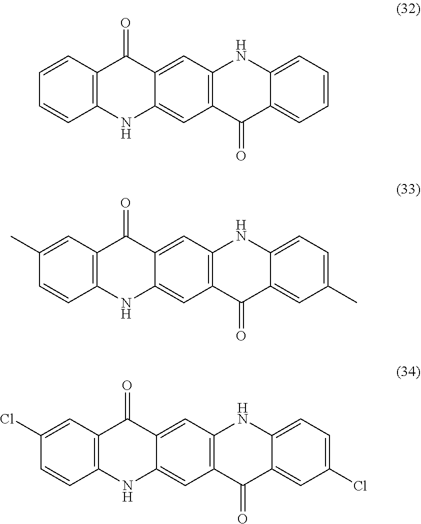

### 4.2 Final Formulation of Electrophoretic Ink Dispersion Comprising Magenta Pigment Particles

30 mg of N,N-dialkylamino-propyl-polydimethylsiloxane as described in 1.2 (one or more examples selected from compound (9), (10), (11), (12), (13), and/or (15)) and 80 mg of methyl-dialkyl-ammoniumpropyl-polydimethylsiloxane as described in 1.3 (one or more examples selected from compound (16), (17), (18), (19), (20), (21), (22), (23), and/or (24)) or 80 mg of ethyl-dialkyl-ammoniumpropyl-polydimethylsiloxane as described in 1.4 (compound (25) or (26) or their mixture) are dissolved in 290 mg of carrier fluid (one or more examples selected from alkanes, halogenated or partially halogenated alkanes, and/or siloxanes), resulting in a charge control agent solution. 600 mg of electrophoretic ink dispersion as described in 4.1 is added to the charge control agent solution. The mixture is dispersed with 1 g of zirconium dioxide beads (diameter: 0.5 mm) for 15 hours in a vial set in a Skandex shaker.

### 4.3 Switching-Test of Electrophoretic Ink Dispersion Comprising Magenta Pigment Particles

A droplet of the electrophoretic ink dispersion comprising magenta pigment particles as described in 3.2 is spread on a glass substrate with an ITO (indium tin oxide) pattern consisting of two series of oppositely charged electrodes with 30-60 μm gap in-between and covered with a cover glass. The thickness of the liquid layer is controlled by a spherical spacer material (diameter: 15 μm). The ITO substrate is driven with 20V, 40V, 60V, or 80V block wave with a frequency of 1.0 Hz. The pigment particles switch between electrodes under the above mentioned driving conditions.

### 5. Electrophoretic Ink Dispersion Comprising Yellow Pigment Particles

### 5.1 Initial Formulation of Electrophoretic Ink Dispersion Comprising Yellow Pigment Particles

0.5 g of N,N-dialkylamino-propyl-polydimethylsiloxane as described in 1.2 (one or more examples selected from compound (9), (10), (11), (12), (13), and/or (15)) and 1.0 g of methyl-dialkyl-ammoniumpropyl-polydimethylsiloxane as described in 1.3 (one or more examples selected from compound (16), (17), (18), (19), (20), (21), (22), (23), and/or (24)) or 1.0 g of ethyl-dialkyl-ammoniumpropyl-polydimethylsiloxane as described in 1.4 (compound (25) or (26) or their mixture) are dissolved in 7.95 g of carrier fluid (one or more examples selected from alkanes, halogenated or partially halogenated alkanes, and/or siloxanes), resulting in a charge control agent solution. 0.5 g of yellow pigment particles (one or more examples selected from compound (35), (36), (37), and/or (38)) and 0.05 g of dispersant (compound (29)) are added to the charge control agent solution. The mixture is dispersed with 50 g of zirconium dioxide beads (diameter: 0.5 mm) for 30 hours in a vial set in a Skandex shaker.

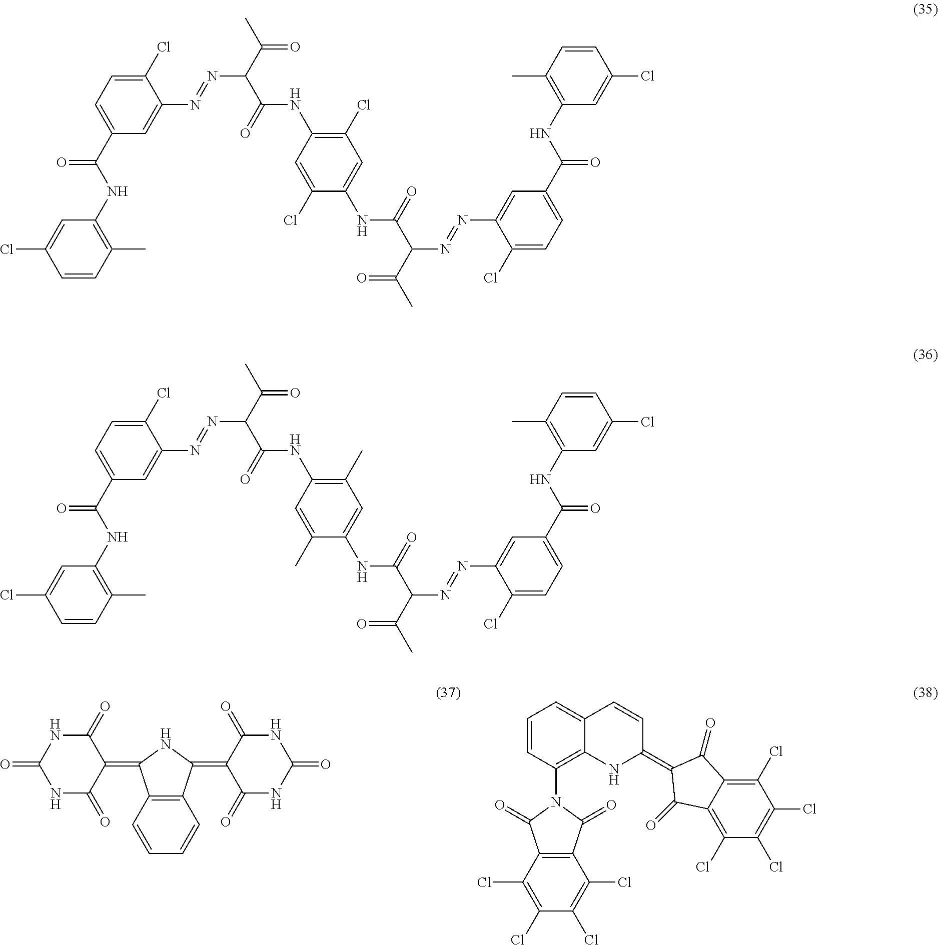 [SMILES: CC(=O)C(/N=N/c1cc(C(=O)Nc2cc(Cl)ccc2C)ccc1Cl)C(=O)Nc1cc(Cl)c(NC(=O)C(/N=N/c2cc(C(=O)Nc3cc(Cl)ccc3C)ccc2Cl)C(C)=O)cc1Cl ; CC(=O)C(/N=N/c1cc(C(=O)Nc2cc(Cl)ccc2C)ccc1Cl)C(=O)Nc1cc(C)c(NC(=O)C(/N=N/c2cc(C(=O)Nc3cc(Cl)ccc3C)ccc2Cl)C(C)=O)cc1C ; O=C1NC(=O)C(=c2[nH]c(=C3C(=O)NC(=O)NC3=O)c3ccccc23)C(=O)N1 ; O=C1C(=C2C=Cc3cccc(N4C(=O)c5c(Cl)c(Cl)c(Cl)c(Cl)c5C4=O)c3N2)C(=O)c2c(Cl)c(Cl)c(Cl)c(Cl)c21]

### 5.2 Final Formulation of Electrophoretic Ink Dispersion Comprising Yellow Pigment Particles

30 mg of N,N-dialkylamino-propyl-polydimethylsiloxane as described in 1.2 (one or more examples selected from compound (9), (10), (11), (12), (13), and/or (15)) and 80 mg of methyl-dialkyl-ammoniumpropyl-polydimethylsiloxane as described in 1.3 (one or more examples selected from compound (16), (17), (18), (19), (20), (21), (22), (23), and/or (24)) or 80 mg of ethyl-dialkyl-ammoniumpropyl-polydimethylsiloxane as described in 1.4 (compound (25) or (26) or their mixture) are dissolved in 290 mg of carrier fluid (one or more examples selected from alkanes, halogenated or partially halogenated alkanes, and/or siloxanes), resulting in a charge control agent solution. 600 mg of electrophoretic ink dispersion as described in 5.1 is added to the charge control agent solution. The mixture is dispersed with 1 g of zirconium dioxide beads (diameter: 0.5 mm) for 15 hours in a vial set in a Skandex shaker.

### 5.3 Switching-Test of Electrophoretic Ink Dispersion Comprising Yellow Pigment Particles

A droplet of the electrophoretic ink dispersion comprising yellow pigment particles as described in 5.2 is spread on a glass substrate with an ITO (indium tin oxide) pattern consisting of two series of oppositely charged electrodes with 30-60 μm gap in-between and covered with a cover glass. The thickness of the liquid layer is controlled by a spherical spacer material (diameter: 15 μm). The ITO substrate is driven with 20V, 40V, 60V, or 80V block wave with a frequency of 1.0 Hz. The pigment particles switch between electrodes under the above mentioned driving conditions.

1: An electrophoretic ink, comprising,
a) at least one carrier fluid,
b) pigment particles dispersed in the at least one carrier fluid, and
c) a mixture of charge control agents comprising
i) at least one polydimethylsiloxane substituted primary amine and/or polydimethylsiloxane substituted secondary amine and/or polydimethylsiloxane substituted tertiary amine, and
ii) at least one polydimethylsiloxane substituted quaternary ammonium with counterion.

2: The electrophoretic ink of claim 1, wherein the at least one carrier fluid comprises an aliphatic hydrocarbon, a halogenated alkane, a silicon oil and mixtures thereof.

3: The electrophoretic ink of claim 1, wherein the pigment particles are selected from the group consisting of a color pigment, an effect pigment, an electrically conductive pigment, a magnetically shielding pigment, a fluorescent pigment, an extender pigment, an anticorrosion pigment, an organic pigment, an inorganic pigment and mixtures thereof.

4: The electrophoretic ink of claim 1, further comprising at least one dispersing agent of Formula (I) 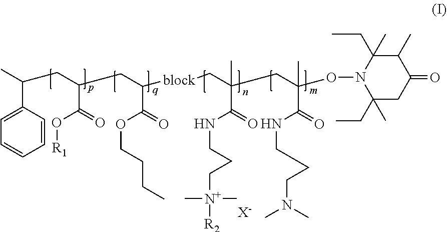
wherein p+q is an integer in a range of from 30 to 200,
n+m is an integer in a range of from 5 to 50,
X⁻ is an anion of a monovalent organic or inorganic acid,
R₁ is a C₄-C₂₂-linear or branched alkyl group and
R₂ is a C₁-C₁₂-comprising group.

5: The electrophoretic ink of claim 1, wherein the mixture of charge control agents comprises the at least one polydimethylsiloxane substituted primary amine and/or polydimethylsiloxane substituted secondary amine and/or polydimethylsiloxane substituted tertiary amine of i) and the at least one polydimethylsiloxane substituted quaternary ammonium with counterion of ii) in a weight ratio ranging from 1:10 to 1:1.5.

6: The electrophoretic ink of claim 1, wherein the at least one polydimethylsiloxane substituted primary amine and/or polydimethylsiloxane substituted secondary amine and/or polydimethylsiloxane substituted tertiary amine of i) is a polydimethylsiloxane substituted tertiary amine.

7: The electrophoretic ink of claim 1, wherein the at least one polydimethylsiloxane substituted primary amine and/or polydimethylsiloxane substituted secondary amine and/or polydimethylsiloxane substituted tertiary amine of i) is
a compound of Formula (IIa) 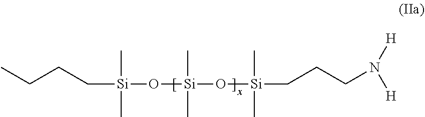
wherein x is an integer in a range of from 5 to 20, and/or
a compound of Formula (IIb) 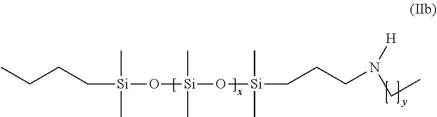
wherein x is an integer in a range of from 5 to 20 and
y is an integer in a range of from 0 to 12, and/or
a compound of Formula (IIc) 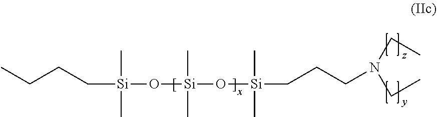
wherein x is an integer in a range of from 5 to 20 and
y and z are each independently an integer in a range of from 0 to 12.

8: The electrophoretic ink of claim 1, wherein the at least one polydimethylsiloxane substituted quaternary ammonium with counterion of ii) is a compound of Formula (III) 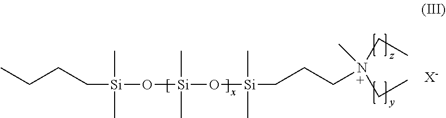
wherein x is an integer in a range of from 5 to 20;
y and z are each independently an integer in a range of from 0 to 12 and
X⁻ is selected from the group consisting of iodide, bromide, chloride, methylsulfate anion and ethylsulfate anion.

9: The electrophoretic ink of claim 1, wherein the at least one polydimethylsiloxane substituted quaternary ammonium with counterion of ii) is a compound of Formula (IV) 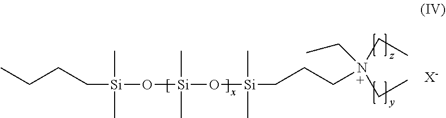
wherein x is an integer in a range of from 5 to 20;
y and z are each independently an integer in a range of from 0 to 12 and
X⁻ is selected from the group consisting of iodide, bromide, chloride, methylsulfate anion and ethylsulfate anion.

10: The electrophoretic ink of claim 7, wherein
x is the same in Formula (II) and Formula (III) or Formula (IV) and/or
y is the same in Formula (II) and Formula (III) or Formula (IV) and/or
z is the same in Formula (II) and Formula (III) or Formula (IV).

11: The electrophoretic ink of claim 1, comprising the mixture of charge control agents in an amount of 5 to 40 wt. % based on a total weight of the electrophoretic ink.

12: A method of preparing an electrophoretic ink, the method comprising:
a) providing at least one carrier fluid as defined in claim 1,
b) providing pigment particles as defined in claim 1,
c) optionally providing at least one dispersing agent of Formula (I) 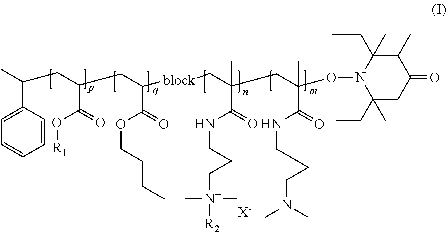
wherein p+q is an integer in a range of from 30 to 200,
n+m is an integer in a range of from 5 to 50,
X⁻ is an anion of a monovalent organic or inorganic acid,
R₁ is a C₄-C₂₂-linear or branched alkyl group and
R₂ is a C₁-C₁₂-comprising group,
d) providing a mixture of charge control agents as defined in claim 1, optionally in a weight ratio [i)/ii)] ranging from 1:10 to 1:1.5, and
e) combining the at least one carrier fluid of a), the pigment particles of b), the optional at least one dispersing agent of c) and the mixture of charge control agents of d).

13: An electrophoretic display, comprising:
a) a top layer and a bottom layer, wherein at least one of the top layer and the bottom layer is transparent, and
b) an array of cells sandwiched between the top layer and the bottom layer, wherein the cells comprise the electrophoretic ink of claim 1.

14: A smart window, comprising
a) a top layer and a bottom layer, wherein at least one of the top layer and the bottom layer is transparent, and
b) an array of cells sandwiched between the top layer and the bottom layer, wherein the cells comprise the electrophoretic ink of claim 1.

15: An electrophoretic display or smart window, comprising the electrophoretic ink of claim 1.

16. A method of preparing an electrophoretic ink, the method comprising mixing components, wherein at least one of the components is a mixture of charge control agents as defined in claim 1.
